(19) United States
(12) Patent Application Publication
(10) Pub. No.: US 2026/0278280 A1
(43) Pub. Date: Sep. 17, 2026

(54) Geometric Robot Control and Motion Planning Using Federated Manifold Cognitive Architecture

(71) Applicant: AtomBeam Technologies Inc., Moraga, CA (US)

(72) Inventor: Brian Galvin, Silverdale, WA (US)

(21) Appl. No.: 19/679,578

(22) Filed: May 15, 2026

Related U.S. Application Data
(63) Continuation-in-part of application No. 19/649,400, filed on Apr. 16, 2026.
Application No. 19/649,400 is a continuation-in-part of application No. 19/550,709, filed on Feb. 26, 2026.
Application No. 19/550,709 is a continuation-in-part of application No. 19/548,024, filed on Feb. 24, 2026.
Application No. 19/548,024 is a continuation-in-part of application No. 19/546,407, filed on Feb. 22, 2026.
Application No. 19/546,407 is a continuation-in-part of application No. 19/534,677, filed on Feb. 9, 2026, now Pat. No. 12,651,010.
(63) Continuation-in-part of application No. 19/632,883, filed on Mar. 30, 2026.
Application No. 19/632,883 is a continuation-in-part of application No. 19/550,709, filed on Feb. 26, 2026.
Application No. 19/550,709 is a continuation-in-part of application No. 19/458,392, filed on Jan. 23, 2026.
Application No. 19/458,392 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/901,793, filed on Oct. 19, 2025.
(60) Provisional application No. 63/941,637, filed on Dec. 15, 2025.
(60) Provisional application No. 63/941,642, filed on Dec. 15, 2025.
(60) Provisional application No. 63/965,251, filed on Jan. 21, 2026.
(60) Provisional application No. 63/965,273, filed on Jan. 21, 2026.
(60) Provisional application No. 63/965,321, filed on Jan. 21, 2026.
(60) Provisional application No. 63/965,242, filed on Jan. 21, 2026.
(60) Provisional application No. 63/966,904, filed on Jan. 23, 2026.
(60) Provisional application No. 63/966,944, filed on Jan. 23, 2026.
(60) Provisional application No. 63/966,955, filed on Jan. 23, 2026.
(60) Provisional application No. 63/967,705, filed on Jan. 25, 2026.
(60) Provisional application No. 63/967,707, filed on Jan. 25, 2026.
(60) Provisional application No. 63/967,710, filed on Jan. 25, 2026.
(60) Provisional application No. 63/967,713, filed on Jan. 25, 2026.
(60) Provisional application No. 63/967,715, filed on Jan. 25, 2026.
(60) Provisional application No. 63/967,718, filed on Jan. 25, 2026.
(60) Provisional application No. 63/967,721, filed on Jan. 25, 2026.
(60) Provisional application No. 63/967,726, filed on Jan. 25, 2026.
(60) Provisional application No. 63/968,152, filed on Jan. 26, 2026.
(60) Provisional application No. 63/968,157, filed on Jan. 26, 2026.
(60) Provisional application No. 63/975,311, filed on Feb. 3, 2026.
(60) Provisional application No. 63/975,314, filed on Feb. 3, 2026.
(60) Provisional application No. 63/976,098, filed on Feb. 4, 2026.
(60) Provisional application No. 63/976,101, filed on Feb. 4, 2026.
(60) Provisional application No. 63/976,103, filed on Feb. 4, 2026.
(60) Provisional application No. 63/976,109, filed on Feb. 4, 2026.
(60) Provisional application No. 63/976,115, filed on Feb. 4, 2026.
(60) Provisional application No. 63/978,340, filed on Feb. 9, 2026.
(60) Provisional application No. 63/978,983, filed on Feb. 9, 2026.
(60) Provisional application No. 63/978,991, filed on Feb. 9, 2026.
(60) Provisional application No. 63/978,997, filed on Feb. 9, 2026.
(60) Provisional application No. 63/985,880, filed on Feb. 18, 2026.
(60) Provisional application No. 64/011,093, filed on Mar. 19, 2026.
(60) Provisional application No. 64/011,100, filed on Mar. 19, 2026.
(60) Provisional application No. 64/011,104, filed on Mar. 19, 2026.
(60) Provisional application No. 64/011,106, filed on Mar. 19, 2026.
(60) Provisional application No. 64/011,111, filed on Mar. 19, 2026.
(60) Provisional application No. 64/012,356, filed on Mar. 20, 2026.
(60) Provisional application No. 64/012,364, filed on Mar. 20, 2026.
(60) Provisional application No. 64/012,371, filed on Mar. 20, 2026.
(60) Provisional application No. 64/012,381, filed on Mar. 20, 2026.
(60) Provisional application No. 64/012,389, filed on Mar. 20, 2026.

(51) Int. Cl. G06F 40/30; G06F 16/332; G06F 16/3329

(52) U.S. Cl. CPC G06F 40/30; G06F 16/3325; G06F 16/3329

(57) ABSTRACT

A system and method for controlling a physical system through a federated architecture of epistemically conditioned geometric substrates. A central cognitive manifold encodes intention, planning, and action-selection states and governs deliberative reasoning. A plurality of peripheral manifolds each encode the states and constraints of a respective sensorimotor or environmental domain, including at least a configuration manifold and one or more sensory manifolds. Persistent typed projection operators couple the central manifold to each peripheral manifold and enforce cross-manifold admissibility conditions on projected states. Before any candidate action is executed, the system evaluates federated admissibility by projecting the action into affected peripheral manifold and denying execution if admissibility fails in any one of them. Inadmissible configurations are encoded as irreversible reservoirs that persistently shape future admissibility evaluations without being modifiable by active execution. Cross-manifold coherence monitoring detects plan-execution mismatch across the cycle and triggers corrective intervention when a coherence failure is detected.

### CROSS-REFERENCE TO RELATED APPLICATIONS

Priority is claimed in the application data sheet to the following patents or patent applications, each of which is expressly incorporated herein by reference in its entirety:
Ser. No. 19/649,400
Ser. No. 19/550,709
Ser. No. 19/548,024
Ser. No. 19/546,407
Ser. No. 19/534,677
64/012,356
64/012,364
64/012,371
64/012,381
64/012,389
64/011,093
64/011,100
64/011,104
64/011,106
64/011,111
63/985,880
63/978,340
63/978,983
63/978,991
63/978,997
63/976,098
63/976,101
63/976,103
63/976,109
63/976,115
63/975,311
63/975,314
63/968,152
63/968,157
63/967,705
63/967,707
63/967,710
63/967,713
63/967,715
63/967,718
63/967,721
63/967,726
63/966,904
63/966,944
63/966,955
63/965,251
63/965,273
63/965,321
63/965,242
63/941,637
63/941,642
63/901,793
Ser. No. 19/632,883
Ser. No. 19/458,392
Ser. No. 19/321,173
Ser. No. 19/284,115
Ser. No. 19/051,193
63/847,082
63/847,091
63/847,096
63/847,101

### BACKGROUND OF THE INVENTION

### Field of the Art

The present invention relates to the field of robotics and cognitive computing systems, and more specifically to persistent geometric reasoning architectures for robot control and motion planning using federated manifold representations with cross-domain admissibility constraints.

### Discussion of the State of the Art

Contemporary robotic systems and artificial intelligence-based control architectures operate across multiple heterogeneous domains, including perception, motion planning, control, and task-level reasoning. These domains are typically represented using distinct mathematical models, such as configuration spaces for motion planning, state estimation frameworks for perception, and symbolic or learned representations for high-level reasoning. Existing systems commonly integrate these domains through data fusion pipelines, modular software architectures, or centralized controllers that coordinate information exchange among subsystems. While such approaches have enabled significant advances in robotic capability, they generally treat each domain as an independent representation and rely on external coordination mechanisms to reconcile inconsistencies across domains.

In motion planning and control, widely used techniques such as sampling-based planners, trajectory optimization methods, and model predictive control operate on configuration spaces that encode kinematic feasibility and cost functions. Safety constraints, including collision avoidance, joint limits, and force thresholds, are typically imposed through external constraint functions, penalty terms, or supervisory control layers. Although these techniques can produce feasible trajectories under specified conditions, the constraints governing admissible behavior are not embedded as intrinsic structural properties of the planning space itself. As a result, learned information about previously encountered unsafe configurations is often stored in auxiliary data structures or learned models rather than being incorporated directly into the geometry of the configuration space.

Perception and state estimation systems, including visual processing pipelines, probabilistic filters, and learned sensor models, maintain representations of environmental state that are updated based on incoming sensory data. These representations are frequently fused into a unified world model or used to inform planning modules. However, inconsistencies between perceived states and planned actions are typically handled through reactive correction, replanning, or error recovery mechanisms after discrepancies are detected. There is generally no unified structural framework that enforces consistency of reasoning and execution across perception, planning, and control domains prior to action execution.

Architectures that incorporate learning, including reinforcement learning and end-to-end neural control systems, may implicitly encode relationships among perception, decision-making, and control through learned policies. However, such systems generally lack explicit mechanisms for enforcing admissibility of actions across multiple domains simultaneously. Safety and reliability are often addressed through training procedures, reward shaping, or external safety filters rather than through structural constraints embedded within the representational substrate. Similarly, modular robotic frameworks provide interfaces for communication among components but do not impose intrinsic constraints that prevent the formation or execution of actions that are inconsistent across domains.

Accordingly, existing approaches do not provide a unified geometric framework in which multiple domain-specific representations are coupled in a manner that enforces admissibility of actions across all relevant domains as a precondition to execution, nor do they provide mechanisms for encoding learned inadmissibility patterns directly into the structural properties of those representations such that recurrence of unsafe or inconsistent configurations is prevented by construction.

What is needed is a system in which multiple domain-specific representations are maintained as coupled geometric substrates, where mappings between those substrates enforce admissibility constraints across domains, where constraints and learned inadmissibility patterns are embedded directly into the geometry of those substrates, and where candidate actions are permitted to form or execute only when they are simultaneously admissible across all affected domains, thereby providing structural consistency between perception, planning, and execution and preventing inadmissible or unsafe behavior prior to action execution.

### SUMMARY OF THE INVENTION

Accordingly, the inventor has conceived and reduced to practice a computer system implementing a federated manifold cognitive architecture in which a central cognitive manifold and a plurality of peripheral manifolds operate as epistemically conditioned geometric substrates that jointly govern reasoning and action execution. In contrast to systems that perform reasoning or control within a single representational space or that fuse multiple domains through external coordination, the disclosed system enforces admissibility structurally across multiple coupled manifolds through persistent inter-manifold projection operators carrying cross-manifold admissibility conditions. Candidate cognitive states are admitted for reasoning only when epistemically admissible within the central cognitive manifold, and candidate actions derived from reasoning trajectories are permitted to form or execute only when they are simultaneously admissible across all affected peripheral manifolds. Constraints of a controlled system are encoded directly within a configuration manifold as admissibility boundaries and irreversible reservoir structures that store abstract representations of inadmissible configurations through non-invertible operations and influence future admissibility evaluations through asymmetric feedback. Action trajectories are computed as geodesic paths through the configuration manifold subject to these constraints. The system further monitors cross-manifold epistemic coherence by accumulating a path-dependent coherence quantity across plan-execute-perceive cycles spanning multiple manifolds and detects discontinuities indicating mismatch between planning, execution, and perception. Outputs or actions are generated only when federated admissibility and cross-manifold coherence are maintained, and are suppressed, qualified, or withheld otherwise, thereby providing structural prevention of inadmissible reasoning and execution across coupled domains.

In an embodiment, a computer system maintains a central cognitive manifold and a plurality of peripheral manifolds as geometric substrates for cognitive operations, where the central cognitive manifold encodes cognitive states including intention states, planning states, and action-selection states together with epistemic conditioning information governing admissibility of reasoning trajectories, and each peripheral manifold encodes states of a respective domain together with epistemic conditioning information governing admissibility of operations within that domain, including at least a configuration manifold encoding configuration states of a controlled system and one or more sensory peripheral manifolds encoding environmental observations, and further maintains a plurality of inter-manifold projection operators as persistent typed mappings between the central cognitive manifold and respective peripheral manifolds, each carrying a cross-manifold admissibility condition constraining projection such that projected states satisfy admissibility criteria of a target manifold, evaluates epistemic admissibility of candidate cognitive states within the central cognitive manifold and denies admission by preventing formation of reasoning trajectories when admissibility is not satisfied, computes reasoning trajectories from admitted states and generates candidate actions from action-selection states, evaluates federated admissibility of a candidate action by determining affected peripheral manifolds, projecting the candidate action into each affected manifold through corresponding projection operators, evaluating admissibility of each projected state within its respective manifold, and preventing formation or execution of an action trajectory when admissibility is not satisfied in any affected manifold, encodes constraints of the controlled system as admissibility boundaries and forbidden regions within the configuration manifold and, upon detecting an inadmissible configuration, generates a constraint representation of a structural property of a configuration-space region and projects the representation into irreversible reservoirs through a non-invertible operation that discards reconstructable details while preserving information identifying structurally similar inadmissible configurations and applies asymmetric constraint feedback from the reservoirs to subsequent admissibility evaluations without permitting modification of the reservoirs by active execution, computes an action trajectory as a geodesic path through the configuration manifold that satisfies admissibility boundaries and reservoir barriers, monitors cross-manifold epistemic coherence during a plan-execute-perceive cycle by accumulating a cross-manifold path-dependent coherence quantity across transitions spanning the central cognitive manifold and peripheral manifolds including contributions from manifold traversal and inter-manifold projection transitions and detecting a coherence failure condition comprising a change in the coherence quantity at an inter-manifold transition exceeding a discontinuity threshold, and generates an output or executes an action conditioned on federated admissibility while suppressing, qualifying, or withholding the output or execution when federated admissibility is not satisfied or when a cross-manifold coherence failure condition is detected.

In an aspect of an embodiment, each of the central cognitive manifold and the plurality of peripheral manifolds carries a semantic metric encoding dissimilarity between states, an almost-complex structure restricting admissible deformations, a symplectic form reconstructed from the semantic metric and the almost-complex structure according to a compatibility relation, and an epistemic connection geometrically independent of the semantic metric that assigns transition-specific coherence values such that regions that are identical under the semantic metric may exhibit different epistemic curvature values reflecting different levels of evidential support.

In an aspect of an embodiment, the configuration manifold carries a Riemannian metric derived from task-space geometry such that distances reflect task-relevant operation costs, singularity loci at which a Jacobian is rank-deficient are encoded as degeneracy regions, and admissibility boundaries encode configuration limits as structural geometric features rather than external constraint tables.

In an aspect of an embodiment, the constraint representation projected into irreversible reservoirs encodes a curvature signature of a neighborhood of an inadmissible configuration rather than explicit configuration coordinates, such that asymmetric constraint feedback applies to structurally similar configurations throughout the configuration manifold without storing or reconstructing coordinates of the inadmissible configuration.

In an aspect of an embodiment, the system performs, at a fast timescale corresponding to a sensor update rate, a reactive admissibility evaluation of current configuration states directly within the configuration manifold against admissibility boundaries and reservoir barriers and suppresses execution of a current action trajectory upon detecting inadmissibility without requiring processing by the central cognitive manifold, the reactive evaluation operating at a rate faster than reasoning trajectory computation.

In an aspect of an embodiment, the central cognitive manifold carries an intentional sub-manifold encoding goal states, task context, and priority structure that evolve on a slow timescale and are structurally isolated from fast-timescale perturbations, wherein conflicting goal states generate a degeneracy indicator, and reasoning trajectories originate from goal states and terminate at action-selection states projected to peripheral manifolds for federated admissibility evaluation.

In an aspect of an embodiment, the sensory peripheral manifolds include a visual manifold encoding environmental observations and carrying admissibility boundaries corresponding to detected obstacles and irreversible reservoirs encoding learned hazard patterns, and a spatial world model manifold encoding a persistent geometric model of an operating environment updated by projection from the visual manifold.

In an aspect of an embodiment, the sensory peripheral manifolds further include a haptic manifold encoding force and torque states at an end effector and carrying admissibility boundaries corresponding to force overload conditions, wherein federated admissibility evaluation of actions involving contact requires admissibility within the haptic manifold.

In an aspect of an embodiment, upon detecting a cross-manifold coherence failure condition the system performs at least one of interrupting an action trajectory, initiating a re-planning cycle, or generating a constraint representation of a detected discontinuity and projecting the representation into reservoirs of a peripheral manifold in which the discontinuity is localized, and wherein the inter-manifold projection operators contributing to coherence accumulation are the same persistent typed mappings used for federated admissibility evaluation rather than transient structures.

In an aspect of an embodiment, the plurality of peripheral manifolds includes a language manifold encoding command representations derived from voice or text input, and a linguistic projection operator maps admitted command representations to an intentional sub-manifold of the central cognitive manifold subject to an admissibility condition that denies mapping of commands projecting to forbidden regions or conflicting with committed goal states, and reverse projection generates verbal or textual status expressions consistent with a current geometric state of the central cognitive manifold.

Method embodiments corresponding to the foregoing system embodiments are likewise contemplated, wherein maintaining manifolds, projecting states, evaluating admissibility, computing reasoning trajectories, performing federated admissibility gating, encoding constraints and reservoirs, computing geodesic trajectories, monitoring cross-manifold coherence, and generating or suppressing outputs or actions are performed as computer-implemented methods by a system comprising a hardware memory and one or more processors configured to execute the described operations.

### BRIEF DESCRIPTION OF THE DRAWING FIGURES

FIG. 1 is a block diagram illustrating an overall system architecture of a federated manifold robotic system including a central cognitive manifold, a plurality of peripheral manifolds, inter-manifold projection operators, and associated control and monitoring components.

FIG. 2 is a block diagram illustrating an internal architecture of a central cognitive manifold including an intentional sub-manifold, a planning sub-manifold, and an action-selection layer with associated epistemic conditioning structures.

FIG. 3 is a block diagram illustrating an architecture of a motor configuration manifold including a Riemannian metric, admissibility boundary structures, irreversible collision reservoir structures, and interfaces for trajectory planning and safety evaluation.

FIG. 4 is a block diagram illustrating an architecture of an inter-manifold projection operator including typed mappings, cross-manifold admissibility conditions, and phase contribution paths for coherence monitoring.

FIG. 5 is a block diagram illustrating an architecture of a federated admissibility evaluator configured to perform conjunctive admissibility gating across multiple peripheral manifolds.

FIG. 6 is a flow diagram illustrating a federated admissibility evaluation process including action classification, projection, multi-manifold admissibility evaluation, and iterative re-planning.

FIG. 7 is a flow diagram illustrating cross-manifold holonomy monitoring across a plan-execute-perceive cycle including phase accumulation, discontinuity detection, and intervention.

FIG. 8 is a flow diagram illustrating irreversible collision reservoir formation including detection of inadmissible configurations, constraint representation generation, and persistent reservoir encoding.

FIG. 9 is a flow diagram illustrating multi-timescale operation including fast-timescale reactive safety, intermediate-timescale reasoning and action selection, and slow-timescale reservoir consolidation and manifold evolution.

FIG. 10 is a flow diagram illustrating end-to-end data flow including sensor processing, cognitive planning, federated admissibility evaluation, trajectory execution, and coherence monitoring.

FIG. 11 is a flow diagram illustrating operation of a linguistic projection operator including command parsing, admissibility evaluation, projection into a cognitive manifold, and generation of linguistic output.

FIG. 12 illustrates an exemplary computing environment on which an embodiment described herein may be implemented.

### DETAILED DESCRIPTION OF THE INVENTION

The inventor has conceived and reduced to practice a system and method for controlling a physical or virtual controlled system using a federated manifold cognitive architecture in which a central cognitive manifold and a plurality of peripheral manifolds are maintained as coupled geometric substrates, each carrying epistemic conditioning that governs admissibility of operations within that substrate, and in which actions are permitted to form or execute only when they are simultaneously admissible across all affected substrates. In contrast to approaches that coordinate separate representations through external logic or post hoc validation, the disclosed system embeds constraints, learned inadmissibility patterns, and cross-domain consistency conditions directly into geometric structures and into mappings between those structures, such that inadmissible reasoning trajectories and inadmissible actions are structurally prevented from forming or executing.

In an embodiment, a computer system comprises one or more processors and a nontransitory memory storing instructions that maintain a central cognitive manifold and a plurality of peripheral manifolds. A central cognitive manifold represents cognitive states as locations in a geometric space and reasoning processes as trajectories through that space. A central cognitive manifold encodes at least intention states, planning states, and action-selection states, together with epistemic conditioning information that governs admissibility of reasoning trajectories. Epistemic conditioning may include, for example, admissibility boundaries, capacity constraints, degeneracy indicators, and path-dependent coherence quantities associated with transitions between cognitive states. In an embodiment, a central cognitive manifold carries a semantic metric g that encodes dissimilarity between cognitive states, an almost-complex structure J that restricts admissible deformations of the manifold such that J squared equals negative identity, a symplectic form ω reconstructed from g and J according to a compatibility relation such as ω(X,Y)=g (JX,Y), and an epistemic connection A that assigns transition-specific coherence values to transitions between cognitive states and has curvature F=dA. A connection A is geometrically independent of a semantic metric g, such that regions that are identical under g may exhibit different epistemic curvature values reflecting different levels of evidential support.

In an embodiment, a plurality of peripheral manifolds are maintained as domain-specific geometric substrates, each encoding states of a respective domain together with epistemic conditioning information governing admissibility of operations within that domain. A peripheral manifold may include, for example, a configuration manifold that encodes configuration states of a controlled system, such as joint configurations of a robot, and one or more sensory peripheral manifolds that encode environmental observations. A peripheral manifold may also carry geometric structures analogous to those of a central cognitive manifold, including a semantic metric, an almost-complex structure, a symplectic form, and an epistemic connection, thereby enabling admissibility evaluation and coherence monitoring within each domain.

In an embodiment, a plurality of inter-manifold projection operators are maintained as persistent structures in memory. An inter-manifold projection operator defines a typed mapping between a source manifold and a target manifold, such as from a central cognitive manifold to a peripheral manifold or from a peripheral manifold to a central cognitive manifold. Each inter-manifold projection operator carries an associated cross-manifold admissibility condition that constrains projection such that a projected state is required to satisfy admissibility criteria of a target manifold at a projected location. In an embodiment, a projection operator Φ_ij maps a state from a manifold M_i to a manifold M_j, and admissibility condition A_ij requires that Φ_ij(x) is admissible in M_j according to structural properties of M_j. Projection operators are maintained persistently across successive operation cycles and are not transient constructs.

In an embodiment, a central cognitive manifold evaluates epistemic admissibility of candidate cognitive states prior to allowing formation of reasoning trajectories. Admissibility evaluation may include computing a local capacity measure, evaluating admissibility boundary conditions, detecting degeneracy indicators, and assessing compatibility with path-dependent descriptors. When epistemic admissibility is not satisfied, formation of a reasoning trajectory from a candidate state is prevented. For admitted states, reasoning trajectories are computed through a central cognitive manifold, and a candidate action is generated from an action-selection state reached by an admitted reasoning trajectory.

In an embodiment, a central cognitive manifold carries a planning sub-manifold that serves as a distinct geometric substrate within a central cognitive manifold in which action sequences are computed as reasoning trajectories. A planning sub-manifold receives goal states from an intentional sub-manifold and computes reasoning trajectories that terminate at action-selection states. Reasoning trajectories within a planning sub-manifold are subject to the same epistemic admissibility evaluation and coherence monitoring mechanisms that govern reasoning within a central cognitive manifold, such that planning trajectories that fail admissibility or coherence conditions are interrupted or redirected before producing candidate actions.

In an embodiment, a system evaluates federated admissibility of a candidate action across multiple peripheral manifolds. A set of peripheral manifolds affected by a candidate action is determined based on characteristics of the action. For each affected peripheral manifold, a projected action state is computed by applying a corresponding inter-manifold projection operator to a candidate action. Epistemic admissibility of each projected action state is evaluated within its respective peripheral manifold based on structural properties of that manifold. Federated admissibility is satisfied when projected action states are admissible in all affected peripheral manifolds. When epistemic admissibility is not satisfied in any affected peripheral manifold, formation or execution of an action trajectory corresponding to a candidate action is prevented.

In an embodiment, a set of peripheral manifolds affected by a candidate action is determined based on the type of the candidate action. A motion command affecting the configuration of a controlled system determines a set that includes at least a configuration manifold and a spatial world model manifold. A grasping or contact command determines a set that additionally includes a haptic manifold, such that admissibility of projected force and torque states is evaluated as a condition of execution. An utterance or linguistic command determines a set that includes a language manifold, such that admissibility of a projected command representation within a language manifold is required before the command influences goal states in an intentional sub-manifold. Other action types may determine other combinations of affected peripheral manifolds based on the domains implicated by the action.

In an embodiment, a configuration manifold represents configuration states of a controlled system as a geometric space, such as a Riemannian manifold over a configuration space Q. A Riemannian metric on a configuration manifold may be derived from task-space geometry such that distances reflect task-relevant operation costs rather than raw coordinate differences. Constraints of a controlled system are encoded directly within a configuration manifold as admissibility boundaries and forbidden regions. For example, configuration limits may define boundary surfaces, and singularity loci, such as configurations at which a Jacobian is rank-deficient, may define degeneracy regions. In this manner, constraints are represented as intrinsic geometric features rather than external constraint tables.

In an embodiment, a system encodes learned inadmissibility patterns within a configuration manifold using irreversible reservoirs. When a configuration encountered during execution is determined to be inadmissible, such as during a collision or near-collision event, a constraint representation is generated that characterizes a structural property of a configuration-space region associated with the inadmissible configuration. In an embodiment, a constraint representation encodes a curvature signature of a neighborhood of the inadmissible configuration rather than explicit coordinates. A constraint representation is projected into one or more irreversible reservoirs through a non-invertible operation that discards reconstructable details while preserving information sufficient to identify structurally similar inadmissible configurations in subsequent evaluations. Asymmetric constraint feedback from irreversible reservoirs influences subsequent admissibility evaluations within a configuration manifold while active execution does not modify contents of reservoirs.

In an embodiment, an action trajectory through a configuration manifold is computed as a geodesic path between configurations. For example, given a start configuration q_s and a goal configuration q_g, a geodesic path γ may be computed that minimizes a path length with respect to a Riemannian metric subject to admissibility boundaries and reservoir barriers, such that γ avoids forbidden regions and regions associated with stored inadmissibility patterns. Geodesic computation replaces or augments sampling-based or optimization-based trajectory planning by operating directly on a geometrically conditioned manifold.

In an embodiment, a system monitors cross-manifold epistemic coherence during a plan-execute-perceive cycle. A plan-execute-perceive cycle comprises planning within a central cognitive manifold, execution within a configuration manifold, and perceptual update within one or more sensory peripheral manifolds, followed by projection of updated states back into a central cognitive manifold. A cross-manifold path-dependent coherence quantity is accumulated across transitions spanning multiple manifolds. Accumulation may include contributions from traversal within individual manifolds and contributions from transitions across inter-manifold projection operators. In an embodiment, a coherence quantity may be computed as a sum of phase values assigned by an epistemic connection to transitions, such that Φ(γ)=Σθ over transitions along a composite path γ spanning multiple manifolds. A cross-manifold coherence failure condition may be detected when a change in a coherence quantity at an inter-manifold transition exceeds a discontinuity threshold, indicating a mismatch between planning, execution, and perception. Upon detecting a coherence failure condition, a system may perform intervention including interrupting an action trajectory, initiating re-planning within a central cognitive manifold, or generating a constraint representation associated with a detected discontinuity and projecting that representation into reservoirs of a peripheral manifold in which a discontinuity is localized.

In an embodiment, when federated admissibility is not satisfied for a candidate action, the system does not terminate operation but instead generates one or more alternative candidate actions for evaluation. Alternative candidate actions may be generated by a planning sub-manifold by computing an alternative reasoning trajectory that avoids action-selection states whose projected states were found inadmissible in one or more peripheral manifolds. In an embodiment, the specific peripheral manifold in which admissibility was denied and the nature of the admissibility failure are reported to a planning sub-manifold to inform generation of alternatives. When no admissible alternative candidate action can be generated, the system reports the admissibility failure to an intentional sub-manifold for goal-level revision.

In an embodiment, a system operates on separated timescales. A fast timescale corresponds to a sensor update rate at which peripheral manifolds receive projection updates from sensor inputs. At a fast timescale, a reactive admissibility evaluation may be performed directly within a configuration manifold, such that current configuration states are evaluated against admissibility boundaries and reservoir barriers and execution of a current action trajectory is suppressed upon detecting inadmissibility without requiring processing by a central cognitive manifold. An intermediate timescale corresponds to a reasoning rate at which a central cognitive manifold computes reasoning trajectories and candidate actions and performs federated admissibility evaluation. A slow timescale corresponds to a consolidation rate at which irreversible reservoirs are updated and at which structural properties of manifolds evolve.

In an embodiment, a central cognitive manifold carries an intentional sub-manifold that encodes goal states, task context, and priority structure. Goal states evolve on a slow timescale and are structurally isolated from fast-timescale perturbations by epistemic conditioning of a central cognitive manifold. Conflicting goal states that are mutually inadmissible due to capacity or admissibility constraints generate degeneracy indicators within an intentional sub-manifold. Reasoning trajectories originate from goal states within an intentional sub-manifold and terminate at action-selection states from which candidate actions are projected to peripheral manifolds for federated admissibility evaluation.

In an embodiment, a sensory peripheral manifold includes a visual manifold that encodes environmental observations, such as three-dimensional spatial information, and carries admissibility boundaries corresponding to detected obstacles and irreversible reservoirs encoding learned hazard patterns. A spatial world model manifold may be maintained as a persistent geometric model of an operating environment, updated by projection from a visual manifold and other sensory peripheral manifolds. In an embodiment, a sensory peripheral manifold includes a haptic manifold that encodes force and torque states at an end effector of a controlled system and carries admissibility boundaries corresponding to force overload conditions, such that federated admissibility evaluation of actions involving contact requires admissibility within a haptic manifold.

In an embodiment, a system includes a language manifold that encodes command representations derived from voice or text input. A linguistic projection operator defines a mapping from a language manifold to an intentional sub-manifold of a central cognitive manifold, subject to an admissibility condition that denies mapping of command representations that would project to forbidden regions or that conflict with committed goal states. Reverse projection from a central cognitive manifold through a linguistic projection operator to a language manifold may generate verbal or textual status expressions consistent with a current geometric state of a central cognitive manifold.

In an embodiment, a system generates an output or executes an action conditioned on federated admissibility and cross-manifold epistemic coherence. When federated admissibility is not satisfied in any affected peripheral manifold or when a cross-manifold coherence failure condition is detected, output or execution is suppressed, qualified, or withheld, thereby preventing inadmissible reasoning and execution outcomes.

In an embodiment, inter-manifold projection operators are persistent structures maintained in memory across successive operation cycles and are not ephemeral synchronizers as disclosed in the parent application directed to cross-node ephemeral syncing. An ephemeral synchronizer as disclosed in that parent application is a transient cognitive substrate having a bounded lifetime, subject to mandatory dissolution upon completion of a synchronization session, and designed to coordinate independent persistent cognitive machines through adjudicated delta write-back. An inter-manifold projection operator, by contrast, is a permanent architectural coupling between two manifolds within a single federated system, is not dissolved after any individual operation, does not adjudicate deltas, and does not destroy state upon completion of an operation cycle. The two mechanisms are complementary and may coexist within a system without conflict, but they are structurally and functionally distinct.

In an embodiment, a fast timescale corresponds to a sensor update rate on the order of one to ten milliseconds, at which peripheral manifolds receive projection updates from sensor inputs and at which a reactive admissibility evaluation may be performed directly within a configuration manifold. An intermediate timescale corresponds to a reasoning rate on the order of fifty to five hundred milliseconds, at which a central cognitive manifold computes reasoning trajectories and candidate actions and initiates federated admissibility evaluation across affected peripheral manifolds. A slow timescale corresponds to a consolidation rate on the order of seconds to minutes, at which irreversible reservoirs are updated by consolidation of accumulated inadmissibility patterns, goal states within an intentional sub-manifold may be revised, and geometric structures across manifolds evolve under compression and relaxation flows. These timescale ranges are illustrative and non-limiting; specific ranges may vary based on the physical characteristics of a controlled system, sensor hardware, and computational resources available to the system.

In a non-limiting use case example, the system operates as a robotic manipulator arm performing a pick-and-place task in a cluttered industrial environment. A human operator issues a voice command instructing the robot to retrieve an object from a designated location and place it at a target location. The language manifold receives the voice input and encodes a parsed command representation as a cognitive state within its epistemically conditioned geometric substrate. The linguistic projection operator evaluates admissibility of the command representation before projecting it to the intentional sub-manifold of the central cognitive manifold. The command representation is found admissible and is projected to the intentional sub-manifold, where it establishes a goal state encoding the retrieval and placement objectives. The goal state does not conflict with any committed goal states within the intentional sub-manifold, and no degeneracy indicator is generated.

At the intermediate timescale, the planning sub-manifold computes a reasoning trajectory originating from the newly established goal state and terminating at an action-selection state corresponding to a motion command directing the end effector toward the retrieval location. The reasoning trajectory is monitored for epistemic coherence during traversal and remains within the coherent phase regime throughout. A candidate action corresponding to the planned approach motion is generated at the action-selection layer and forwarded to the federated admissibility evaluator.

The federated admissibility evaluator determines that the candidate motion command affects the configuration manifold and the spatial world model manifold. The inter-manifold projection operator maps the candidate action to a projected configuration state within the configuration manifold and to a projected spatial state within the spatial world model manifold. Within the configuration manifold, the projected configuration state is evaluated against admissibility boundaries encoding joint limits and singularity loci and against irreversible reservoir barriers encoding curvature signatures of previously encountered collision configurations. The projected state is found admissible. Within the spatial world model manifold, the projected spatial state is evaluated against admissibility boundaries corresponding to obstacle-occupied regions derived from prior visual manifold projections. The projected state is likewise found admissible. Federated admissibility is satisfied across all affected peripheral manifolds, and the candidate action is approved for execution.

The geodesic trajectory planner computes a geodesic path through the configuration manifold from the current joint configuration to the goal configuration, navigating around admissibility boundaries and reservoir barriers. The planned trajectory is issued to the robot actuator interface for execution. During execution, the reactive admissibility layer continuously evaluates current joint states at the fast timescale directly within the configuration manifold. Midway through the approach motion, a previously undetected obstacle enters the workspace and the visual manifold updates its admissibility boundaries to reflect the new obstacle location. The updated spatial world model manifold projects a revised admissibility boundary that intersects the planned trajectory. At the fast timescale, the reactive admissibility layer detects that a forthcoming trajectory segment approaches an admissibility-denied region and suppresses execution of that segment without waiting for central cognitive manifold processing, halting the arm before contact occurs.

The cross-manifold holonomy monitor, accumulating cross-manifold phase across the plan-execute-perceive cycle, detects a cross-manifold phase discontinuity at the transition between the configuration manifold and the spatial world model manifold, indicating a mismatch between the planned trajectory and the updated environmental geometry. The monitor generates a coherence failure signal and initiates a re-planning cycle within the central cognitive manifold. A constraint representation characterizing the curvature signature of the configuration-space region near the suppressed trajectory segment is generated and projected into the irreversible reservoirs of the configuration manifold, encoding the encountered hazard as a persistent geometric constraint that will influence admissibility evaluations in future operation cycles without storing explicit configuration coordinates and without being modifiable by active execution.

The planning sub-manifold computes a revised reasoning trajectory from the current goal state that avoids the updated obstacle region. The revised candidate action is submitted to the federated admissibility evaluator, which confirms admissibility across all affected peripheral manifolds. A revised geodesic trajectory is computed through the configuration manifold and issued for execution. The end effector successfully reaches the retrieval location. Upon grasping the object, the haptic manifold receives force and torque sensor inputs and evaluates the contact configuration against its admissibility boundaries. The contact force is within admissible bounds and no haptic admissibility denial is generated. The system proceeds to execute the placement motion, completing the pick-and-place task.

Over successive operation cycles, accumulated irreversible reservoir content within the configuration manifold reflects the geometry of obstacle-adjacent regions encountered during prior tasks, progressively raising the effective admissibility barrier for configurations near those regions throughout the configuration manifold. The intentional sub-manifold evolves on the slow timescale to reflect updated task priorities communicated through subsequent voice commands, while the fast-timescale reactive safety layer and intermediate-timescale federated admissibility evaluation continue to operate independently of goal-level revision, ensuring that reactive physical safety and deliberative cognitive planning remain structurally decoupled throughout system operation.

The foregoing use case example is non-limiting in nature and illustrates one embodiment of the disclosed architecture operating in a robotic manipulation context. Many embodiments and use cases exist across diverse domains in which multi-domain admissibility gating, persistent constraint learning, and cross-domain coherence monitoring are required. The systems and methods disclosed herein may be applied, without limitation, to robotic manipulator arms performing assembly, inspection, or materials handling tasks in structured or unstructured environments; to mobile robots and autonomous ground vehicles navigating dynamic environments in which collision avoidance, path planning, and task execution must be coordinated across sensory and configuration domains simultaneously; to humanoid robotic systems in which whole-body motion planning must satisfy admissibility conditions across a large number of coupled configuration and sensory domains; to autonomous aerial vehicles in which control actions must be simultaneously admissible with respect to flight envelope constraints, obstacle geometry, and mission planning states; to prosthetic and assistive robotic devices in which physical safety constraints must be enforced at sensor rate while deliberative control operates at a slower cognitive rate; and to industrial process control systems in which configuration states of a controlled process must satisfy admissibility conditions derived from multiple sensory monitoring domains before control actions are permitted to execute. Across these use cases, the technical effect of the invention is the structural prevention of inadmissible actions through federated geometric conditioning of multiple coupled substrates, such that unsafe, incoherent, or inadmissible operations are excluded from formation and execution regardless of the particular physical domain, sensor modality, or control application. The foregoing list of applications is illustrative and non-exhaustive, and the principles disclosed herein are applicable to any system in which actions must satisfy admissibility conditions across multiple coupled geometric domains simultaneously.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “action trajectory” refers to a sequence of configuration states or control states corresponding to execution of an action within a configuration manifold, the sequence representing a path through the configuration manifold subject to admissibility constraints.

As used herein, “admissibility boundary” refers to a structural boundary within a manifold that separates regions in which operations or trajectories are permitted from regions in which such operations or trajectories are restricted or disallowed based on epistemic or geometric constraints.

As used herein, “almost-complex structure” refers to a tensor field on a manifold that assigns to each tangent space a linear map whose square equals negative identity, thereby constraining admissible geometric transformations of the manifold.

As used herein, “asymmetric constraint feedback” refers to influence exerted by stored constraint representations on subsequent admissibility evaluations or trajectory formation, wherein the stored constraint representations are not modifiable by active reasoning or execution processes.

As used herein, “central cognitive manifold” refers to a geometric substrate that encodes cognitive states including intention states, planning states, and action-selection states, and in which reasoning is performed as trajectories subject to epistemic admissibility constraints.

As used herein, “configuration manifold” refers to a manifold that encodes configuration states of a controlled system, such as positions, orientations, or joint states, and that includes structural constraints governing admissibility of configurations and transitions between configurations.

As used herein, “constraint representation” refers to a representation derived from an inadmissible state or trajectory that characterizes structural properties of a region of a manifold, wherein the representation is generated through a non-invertible operation that discards reconstructable details while preserving information sufficient to identify structurally similar inadmissible patterns.

As used herein, “controlled system” refers to a physical or virtual system whose state evolves over time and whose behavior is influenced by actions generated by a cognitive or control process.

As used herein, “cross-manifold admissibility condition” refers to a condition associated with an inter-manifold projection operator that requires a projected state to satisfy admissibility criteria of a target manifold at a projected location.

As used herein, “cross-manifold epistemic coherence” refers to preservation of consistency of reasoning and execution across multiple manifolds, as measured by a path-dependent coherence quantity accumulated across transitions spanning those manifolds.

As used herein, “degeneracy region” refers to a region of a manifold characterized by structural inconsistency, instability, or constraint conflict, such that operations or trajectories within that region are restricted or require special handling.

As used herein, “epistemic admissibility” refers to a structural determination of whether a state or trajectory is permitted to exist or be executed within a manifold based on one or more geometric or evidential constraints encoded in that manifold.

As used herein, “epistemic conditioning” refers to embedding within a manifold structural information that governs admissibility, coherence, and capacity of states and trajectories independently of semantic similarity alone.

As used herein, “epistemic connection” refers to a geometric structure defined on transitions between states in a manifold that assigns transition-specific coherence values and gives rise to a computable epistemic curvature.

As used herein, “epistemic curvature” refers to a quantity derived from an epistemic connection that measures cumulative inconsistency or rotation of evidential grounding over a closed path or local neighborhood within a manifold.

As used herein, “federated admissibility” refers to a determination that a candidate action or trajectory is admissible only when corresponding projected states are admissible within each of a plurality of affected manifolds.

As used herein, “geodesic path” refers to a path through a manifold that locally minimizes a distance or cost function defined by a metric of the manifold, subject to admissibility constraints.

As used herein, “inter-manifold projection operator” refers to a persistent typed mapping between a source manifold and a target manifold that defines how states are transformed between the manifolds and that carries an associated cross-manifold admissibility condition.

As used herein, “intentional sub-manifold” refers to a substructure within a central cognitive manifold that encodes goal states, task context, or priority relationships that influence generation of reasoning trajectories.

As used herein, “irreversible reservoir” refers to a storage structure configured to retain constraint representations derived from inadmissible states or trajectories, wherein stored representations influence future admissibility evaluations through asymmetric constraint feedback and are not modifiable by active execution.

As used herein, “language manifold” refers to a manifold that encodes linguistic or symbolic representations of commands, queries, or communications, and that may be coupled to a central cognitive manifold through a projection operator.

As used herein, “manifold” refers to a geometric representational substrate in which states correspond to locations and transitions correspond to paths, the manifold optionally carrying one or more structures including a metric, an almost-complex structure, a symplectic form, or an epistemic connection.

As used herein, “non-invertible operation” refers to a mapping that transforms a representation into a form from which original details cannot be reconstructed, while preserving information sufficient for identifying structural similarity.

As used herein, “path-dependent coherence quantity” refers to a value accumulated along a sequence of transitions that reflects preservation or loss of epistemic consistency along a trajectory.

As used herein, “peripheral manifold” refers to a manifold associated with a specific domain, such as perception, configuration, or interaction, that is coupled to a central cognitive manifold through one or more inter-manifold projection operators.

As used herein, “plan-execute-perceive cycle” refers to a sequence of operations comprising generation of a plan within a cognitive manifold, execution of an action within a configuration manifold, and update of state based on sensory input within one or more peripheral manifolds.

As used herein, “reactive admissibility evaluation” refers to an evaluation of admissibility performed at a timescale corresponding to sensor updates, in which current states are assessed directly within a manifold without requiring higher-level reasoning processes.

As used herein, “semantic metric” refers to a metric defined on a manifold that encodes dissimilarity between states and determines distances and neighborhood relationships within the manifold.

As used herein, “sensory peripheral manifold” refers to a peripheral manifold that encodes information derived from one or more sensors, including but not limited to visual, haptic, or auditory data.

As used herein, “symplectic form” refers to a non-degenerate, closed bilinear form defined on a manifold that is compatible with a metric and an almost-complex structure and that encodes structural capacity or area-like properties.

### Conceptual Architecture of a Federated Manifold Robotic System

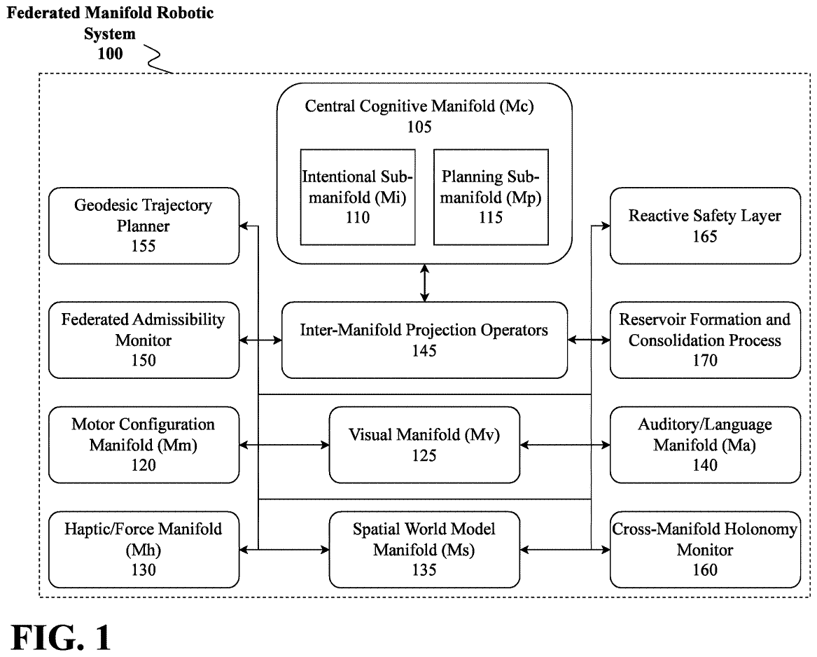

FIG. 1 is a block diagram illustrating an exemplary architecture of a federated manifold robotic system 100. Federated manifold robotic system 100 receives input data including sensor inputs from one or more sensors of a controlled system, including joint state measurements, visual observations, and force or torque measurements, and optionally receives command inputs including linguistic inputs such as voice or text commands. These inputs are projected into corresponding peripheral manifolds for admissibility evaluation and integration into cognitive processing.

Federated manifold robotic system 100 as illustrated in an embodiment comprises a central cognitive manifold 105 coupled to a plurality of peripheral manifolds through a set of inter-manifold projection operators 145, together with a federated admissibility evaluator 150, a geodesic trajectory planner 155, a cross-manifold holonomy monitor 160, a reactive safety layer 165, and a reservoir formation and consolidation process 170. The components cooperate to control a physical or virtual controlled system by generating and executing action trajectories while preventing execution of configurations that fail admissibility conditions across one or more geometric substrates.

Central cognitive manifold 105 serves as a geometric substrate encoding cognitive states comprising intention states, planning states, and action-selection states, together with epistemic conditioning information governing admissibility of reasoning trajectories. Central cognitive manifold 105 may maintain representations of state embeddings, admissibility boundaries, and path-dependent coherence values. Central cognitive manifold 105 carries a semantic metric encoding dissimilarity between cognitive states, an almost-complex structure constraining admissible deformations, a symplectic form derived from those structures, and an epistemic connection assigning transition-specific coherence values to transitions between cognitive states. These structures are usable, for example, to evaluate admissibility of candidate states based on capacity, boundary conditions, or degeneracy. Central cognitive manifold 105 receives admitted sensory projections from peripheral manifolds, generates candidate actions at an action-selection layer, forwards candidate actions to federated admissibility evaluator 150, and receives admissibility verdicts and coherence failure signals that may trigger modification or recomputation of reasoning trajectories.

Intentional sub-manifold 110 within central cognitive manifold 105 encodes goal states, task context, and priority structure that evolve on a slow timescale and are structurally isolated from fast-timescale perturbations. Intentional sub-manifold 110 may maintain goal representations, priority weights, and compatibility relationships. Conflicting goal states that are mutually inadmissible may generate a degeneracy indicator that prevents simultaneous pursuit of incompatible objectives. Intentional sub-manifold 110 receives goal updates from reservoir formation and consolidation process 170 and, when present, from a linguistic projection operator associated with auditory/language manifold 140, and forwards goal states to planning sub-manifold 115.

Planning sub-manifold 115 within central cognitive manifold 105 provides a geometric substrate in which action sequences are computed as reasoning trajectories originating from goal states in intentional sub-manifold 110 and terminating at action-selection states. Planning sub-manifold 115 may maintain trajectory representations, transition costs, and coherence annotations. Reasoning trajectories are evaluated using admissibility criteria derived from manifold structures and may be modified or terminated when admissibility or coherence conditions are not satisfied. Planning sub-manifold 115 receives phase regime classifications from cross-manifold holonomy monitor 160 and provides candidate action states to federated admissibility evaluator 150.

Inter-manifold projection operators 145 define persistent typed mappings between source manifolds and target manifolds and carry associated cross-manifold admissibility conditions requiring that projected states satisfy admissibility criteria of target manifolds. Federated admissibility evaluator 150 invokes inter-manifold projection operators 145 to compute projected action states corresponding to a candidate action. Projection operators 145 may maintain mapping parameters and transformation rules associated with source-target pairs and persist across successive operation cycles. Projection operators 145 may also provide transition-specific contributions to a path-dependent coherence quantity accumulated by cross-manifold holonomy monitor 160 and may project sensory state representations from peripheral manifolds into central cognitive manifold 105 during a perceptual update phase.

Motor configuration manifold 120 encodes configuration states of a controlled system as a Riemannian manifold over a configuration space. Motor configuration manifold 120 may maintain representations of joint configurations, admissibility boundaries, degeneracy regions, and reservoir-induced constraint fields. A metric derived from task-space geometry is usable to evaluate distances and trajectory costs such that distances reflect task-relevant motion characteristics. Kinematic constraints are encoded directly as structural geometric features, including configuration limits defining admissibility boundaries and singularity loci defining degeneracy regions. Irreversible reservoirs within motor configuration manifold 120 store constraint representations derived from inadmissible configurations, such as curvature signatures associated with collision events, and provide asymmetric constraint feedback that modifies subsequent admissibility evaluations without storing reconstructable coordinates. Motor configuration manifold 120 receives joint state sensor inputs at a fast timescale, receives projected states from central cognitive manifold 105 at an intermediate timescale, provides admissibility evaluation results to federated admissibility evaluator 150, provides constraint and metric information to geodesic trajectory planner 155, and receives reservoir updates from reservoir formation and consolidation process 170.

Visual manifold 125 encodes environmental observations, object locations, and free-space geometry derived from visual sensors and may maintain representations of obstacle regions, feature maps, and hazard patterns. Admissibility boundaries correspond to obstacle-occupied regions, and irreversible reservoirs may encode learned hazard patterns. When a projected action corresponds to a state intersecting an obstacle region or hazard pattern, visual manifold 125 provides an admissibility denial to federated admissibility evaluator 150. Visual manifold 125 receives visual sensor inputs at a fast timescale, provides admissibility evaluations of projected action states, and projects admitted environmental representations to spatial world model manifold 135 and to central cognitive manifold 105.

Haptic/force manifold 130 encodes end-effector force and torque states and contact geometry and may maintain representations of force thresholds and contact states. Admissibility boundaries correspond to force overload conditions, and irreversible reservoirs encode configurations associated with excessive or unsafe contact. For actions involving contact, admissibility is evaluated within haptic/force manifold 130 and provided to federated admissibility evaluator 150. Haptic/force manifold 130 receives force and torque sensor inputs and may provide phase contributions to cross-manifold holonomy monitor 160 during perceptual update.

Spatial world model manifold 135 encodes a persistent geometric model of an operating environment and may maintain representations of static and dynamic obstacles and occupancy regions. Spatial world model manifold 135 is updated by projection from visual manifold 125 and other sensory peripheral manifolds and provides environmental context for admissibility evaluation and planning. Admissibility boundaries correspond to obstacle-occupied regions, and reservoirs may encode hazard zones derived from prior interactions. Spatial world model manifold 135 provides admissibility evaluations of projected action states and supplies environmental state information to central cognitive manifold 105.

Auditory/language manifold 140 encodes auditory observations and linguistic command representations derived from voice or text input. Command representations are evaluated for admissibility prior to projection to intentional sub-manifold 110 through a linguistic projection operator. Reverse projection from central cognitive manifold 105 may generate linguistic outputs describing system state or action plans.

Federated admissibility evaluator 150 determines whether a candidate action satisfies admissibility conditions across a set of peripheral manifolds affected by that action. Federated admissibility evaluator 150 identifies affected manifolds based on action type, invokes corresponding inter-manifold projection operators 145 to compute projected action states, and aggregates admissibility evaluations returned by each peripheral manifold. A candidate action proceeds when admissibility is satisfied in each affected manifold and is rejected when any affected manifold provides a denial. Federated admissibility evaluator 150 provides admissibility results to central cognitive manifold 105 and, when admissibility is satisfied, to geodesic trajectory planner 155.

Geodesic trajectory planner 155 computes an action trajectory through motor configuration manifold 120 as a path minimizing a metric defined over the manifold while satisfying admissibility boundaries and reservoir-induced constraints. Geodesic trajectory planner 155 receives admitted configurations from central cognitive manifold 105 following a positive admissibility determination, queries motor configuration manifold 120 for constraint and metric information, generates a trajectory for execution by an actuator interface, and provides the trajectory to cross-manifold holonomy monitor 160 as a reference for evaluating execution consistency.

Cross-manifold holonomy monitor 160 accumulates a path-dependent coherence quantity across transitions spanning central cognitive manifold 105, motor configuration manifold 120, and one or more sensory peripheral manifolds. Contributions to the coherence quantity include values derived from traversal within manifolds and transitions across inter-manifold projection operators 145. A discontinuity exceeding a threshold at an inter-manifold transition indicates a mismatch between planned and observed behavior and may trigger interruption of execution, initiation of re-planning, or generation of constraint representations for storage in reservoirs.

Reactive safety layer 165 performs admissibility evaluation of current configuration states directly within motor configuration manifold 120 at a rate corresponding to sensor updates. When a current configuration approaches or enters an inadmissible region, reactive safety layer 165 generates a suppression signal that halts or modifies execution of a trajectory segment without requiring processing by central cognitive manifold 105.

Reservoir formation and consolidation process 170 manages formation and updating of irreversible reservoirs across peripheral manifolds by generating constraint representations based on inadmissibility events, including collision events or force violations. Constraint representations encode structural properties of affected regions and are stored through non-invertible operations that discard reconstructable details while preserving information identifying structurally similar inadmissible regions. Reservoir formation and consolidation process 170 receives inadmissibility event data from federated admissibility evaluator 150, reactive safety layer 165, and cross-manifold holonomy monitor 160, updates reservoir structures within peripheral manifolds, and provides updated constraint information for subsequent admissibility evaluations.

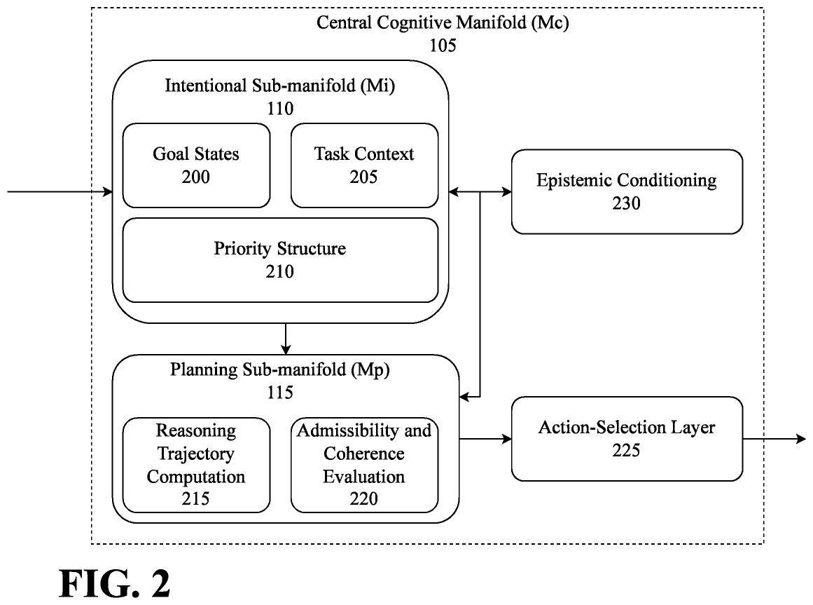

FIG. 2 is a block diagram illustrating exemplary architecture of a central cognitive manifold (Mc) 105 of a federated manifold robotic system 100.

Central cognitive manifold 105 serves as a geometric substrate encoding cognitive states comprising intention states, planning states, and action-selection states, together with epistemic conditioning information governing admissibility of reasoning trajectories. Central cognitive manifold 105 may maintain representations of state embeddings, admissibility boundaries, and path-dependent coherence values. Central cognitive manifold 105 carries a semantic metric encoding dissimilarity between cognitive states, an almost-complex structure constraining admissible deformations, a symplectic form derived from those structures, and an epistemic connection assigning transition-specific coherence values to transitions between cognitive states. These structures are usable, for example, to evaluate admissibility of candidate states based on capacity, admissibility boundary conditions, degeneracy constraints, and accumulated coherence. Epistemic conditioning 230 within central cognitive manifold 105 comprises admissibility boundaries, degeneracy indicators, and irreversible reservoirs that collectively govern which states and transitions are permitted to participate in active reasoning. Admissibility boundaries constrain insertion and traversal of candidate states, degeneracy indicators identify incompatible or unstable state configurations, and irreversible reservoirs modify admissibility evaluation by increasing constraint barriers for structurally similar inadmissible states based on prior system experience. Central cognitive manifold 105 receives admitted sensory state representations projected from peripheral manifolds at an intermediate timescale and receives goal updates from a linguistic projection operator and from consolidation events at a slow timescale. Cross-manifold coherence failure signals received from cross-manifold holonomy monitor 160 may cause central cognitive manifold 105 to modify or abort active reasoning trajectories.

Intentional sub-manifold (Mi) 110 within central cognitive manifold 105 encodes goal states 200, task context 205, and priority structure 210 that evolve on a slow timescale and are structurally isolated from fast-timescale perturbations by epistemic conditioning 230. Goal states 200 represent objectives established through prior consolidation events or through projection from language manifold 140 via a linguistic projection operator. Task context 205 encodes situational information bearing on how goal states 200 are to be pursued, and priority structure 210 encodes ordering relationships among concurrently active goal states 200. Intentional sub-manifold 110 may maintain goal representations, priority weights, and compatibility relationships. Conflicting goal states that are mutually inadmissible due to capacity or admissibility constraints may generate a degeneracy indicator within epistemic conditioning 230 that prevents simultaneous pursuit of incompatible objectives. Goal states 200 from intentional sub-manifold 110 are forwarded to planning sub-manifold 115 to initiate reasoning trajectory computation.

Planning sub-manifold (Mp) 115 within central cognitive manifold 105 provides a geometric substrate in which action sequences are computed as reasoning trajectories originating from goal states 200 in intentional sub-manifold 110 and terminating at action-selection states. Reasoning trajectory computation 215 generates candidate trajectories through the geometric space of central cognitive manifold 105 by traversing state transitions defined by the epistemic connection and constrained by admissibility boundaries and capacity conditions. Planning sub-manifold 115 may maintain trajectory representations, transition costs, and coherence annotations. Admissibility and coherence evaluation 220 evaluates each trajectory against admissibility constraints and accumulated coherence measures, including evaluation of local capacity, admissibility boundary satisfaction, degeneracy conditions, and path-dependent coherence quantities. Trajectories that fail to satisfy these conditions may be modified, redirected, or terminated prior to producing a candidate action. Phase regime classifications received from cross-manifold holonomy monitor 160 may inform admissibility and coherence evaluation 220 during active trajectory computation. Candidate action states produced by planning sub-manifold 115 are forwarded to action-selection layer 225.

Action-selection layer 225 within central cognitive manifold 105 receives candidate action states from planning sub-manifold 115 and selects candidate actions for evaluation by federated admissibility evaluator 150. Action-selection layer 225 causes projection of candidate actions to affected peripheral manifolds via corresponding inter-manifold projection operators 145 for federated admissibility evaluation prior to execution. When federated admissibility evaluator 150 returns a denial, action-selection layer 225 may cause planning sub-manifold 115 to compute an alternative reasoning trajectory that avoids action-selection states whose projected states were found inadmissible in one or more peripheral manifolds. When no admissible alternative candidate action can be generated, action-selection layer 225 may report the admissibility failure to intentional sub-manifold 110 for revision of goal states 200 or priority structure 210.

In an embodiment, data flow through central cognitive manifold 105 proceeds as follows. Admitted sensory projections from peripheral manifolds arrive at central cognitive manifold 105 at an intermediate timescale and are integrated into the geometric state of central cognitive manifold 105, where they may influence admissibility boundary conditions and path-dependent coherence quantities maintained within epistemic conditioning 230. Goal updates arriving from a linguistic projection operator or from consolidation events are received by intentional sub-manifold 110, where they are evaluated for admissibility and, upon admission, establish or revise goal states 200, task context 205, and priority structure 210. Planning sub-manifold 115 receives goal states 200 from intentional sub-manifold 110 and initiates reasoning trajectory computation 215, generating candidate trajectory paths that are evaluated by admissibility and coherence evaluation 220 against the constraints encoded in epistemic conditioning 230. Candidate action states that satisfy admissibility and coherence conditions within planning sub-manifold 115 are forwarded to action-selection layer 225, which projects them to affected peripheral manifolds through inter-manifold projection operators 145 for federated admissibility evaluation by federated admissibility evaluator 150. Upon receiving a positive federated admissibility verdict, action-selection layer 225 forwards the approved candidate action to geodesic trajectory planner 155 for computation of an action trajectory through motor configuration manifold 120. Coherence failure signals received from cross-manifold holonomy monitor 160 during or after execution may cause action-selection layer 225 to suppress a current candidate action or cause planning sub-manifold 115 to revise an active reasoning trajectory, with inadmissibility patterns projected into irreversible reservoirs of epistemic conditioning 230 for influence on subsequent admissibility evaluations.

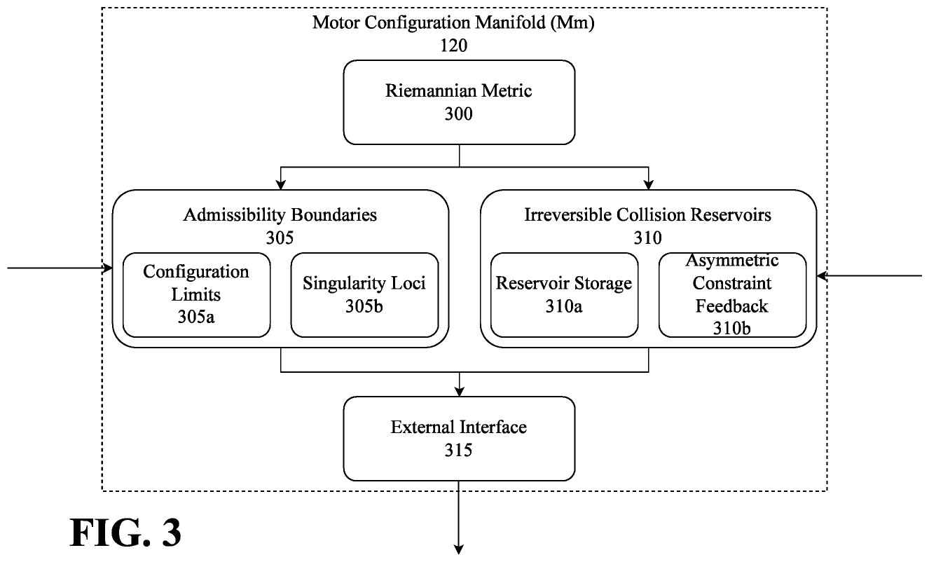

FIG. 3 is a block diagram illustrating exemplary architecture of a motor configuration manifold (Mm) 120 of a federated robotic manifold system 100, in an embodiment.

In an embodiment, motor configuration manifold 120 may include a Riemannian metric 300, admissibility boundary structures 305, irreversible collision reservoir structures 310, and a communication interface 315. Riemannian metric 300 may be derived from task-space geometry of a controlled system such that distances within motor configuration manifold 120 reflect task-relevant operation costs rather than raw coordinate differences. Riemannian metric 300 may be used to govern computation of geodesic paths through motor configuration manifold 120 and to define a cost structure usable by geodesic trajectory planner 155 when computing action trajectories between admitted configurations.

In an embodiment, admissibility boundary structures 305 may include configuration limits 305a and singularity loci 305b. Configuration limits 305a may encode limits of a controlled system as boundary surfaces within configuration space, representing those limits as intrinsic geometric features rather than external constraint tables. Singularity loci 305b may encode configurations at which a Jacobian of a controlled system is rank-deficient as degeneracy regions within motor configuration manifold 120, such that trajectories approaching those regions may be subject to admissibility evaluation prior to traversal. Admissibility boundary structures 305 may evaluate configuration states against geometric boundary conditions defining admissible regions and may generate admissibility determinations for use by other components of system 100.

In an embodiment, irreversible collision reservoir structures 310 may include reservoir storage 310a and asymmetric constraint feedback 310b. Reservoir storage 310a may store constraint representations derived from inadmissible configurations encountered during execution. In an embodiment, a constraint representation may encode a curvature signature of a neighborhood of an inadmissible configuration based on local variation of geometric properties, such as variation of a Riemannian metric or conditioning of a Jacobian, rather than explicit configuration coordinates, such that structurally similar configurations throughout motor configuration manifold 120 may be identified in subsequent evaluations without reconstructing the original configuration. Constraint representations may be written to reservoir storage 310a through non-invertible operations performed by reservoir formation and consolidation process 170.

Asymmetric constraint feedback 310b may apply stored constraint representations to modify admissibility evaluation conditions within motor configuration manifold 120, for example by altering effective admissibility thresholds or boundary conditions for configurations that are structurally similar to stored inadmissible configurations. Asymmetric constraint feedback 310b may operate in a read-only manner with respect to reservoir storage 310a, such that contents of reservoir storage 310a are not modifiable by active execution processes.

Communication interface 315 may be configured to transmit admissibility determinations and constraint-related information between motor configuration manifold 120 and other components of system 100, including federated admissibility evaluator 150, geodesic trajectory planner 155, and reactive safety layer 165. In an embodiment, communication interface 315 may aggregate admissibility determinations derived from admissibility boundary structures 305 and asymmetric constraint feedback 310b and may provide those determinations in a form suitable for use in federated admissibility evaluation and real-time safety enforcement.

At an intermediate timescale, communication interface 315 may provide admissibility determinations corresponding to projected action states to federated admissibility evaluator 150 for inclusion in conjunctive federated admissibility evaluation. At a fast timescale, communication interface 315 may provide admissibility signals to reactive safety layer 165, which may suppress execution of a current action trajectory upon detecting that a current configuration state approaches or enters a region determined to be inadmissible without requiring processing by central cognitive manifold 105. This arrangement enables real-time enforcement of safety constraints directly within motor configuration manifold 120 and reduces repeated traversal into unsafe configuration regions relative to systems that rely on external constraint evaluation.

In an embodiment, data flow through motor configuration manifold 120 may proceed as follows. Joint state sensor inputs may arrive at motor configuration manifold 120 at a fast timescale and may be evaluated by admissibility boundary structures 305 to determine whether current configuration states satisfy geometric constraints encoded within motor configuration manifold 120. When an inadmissible configuration is detected during execution, a constraint representation characterizing a curvature signature of a neighborhood of the inadmissible configuration may be generated and projected into reservoir storage 310a through a non-invertible operation performed by reservoir formation and consolidation process 170. Asymmetric constraint feedback 310b may then apply an influence derived from that stored representation to subsequent admissibility evaluations, modifying admissibility conditions for structurally similar configurations throughout motor configuration manifold 120.

At an intermediate timescale, projected action states received from central cognitive manifold 105 via inter-manifold projection operators 145 may be evaluated against admissibility boundary structures 305 and asymmetric constraint feedback 310b, and resulting admissibility determinations may be transmitted through communication interface 315 to federated admissibility evaluator 150. Upon receiving a positive federated admissibility determination, geodesic trajectory planner 155 may query Riemannian metric 300 and admissibility boundary structures 305 for current metric and constraint information and may compute a geodesic path through motor configuration manifold 120 from an admitted start configuration to a goal configuration, issuing a resulting trajectory to an actuator interface for execution.

At a slow timescale, reservoir formation and consolidation process 170 may update reservoir storage 310a with consolidated inadmissibility patterns accumulated across prior operation cycles. Asymmetric constraint feedback 310b may reflect those updates in subsequent admissibility evaluations without modification by active execution processes, thereby providing persistent structural influence on future trajectory formation and contributing to improved safety and consistency of robot motion over time.

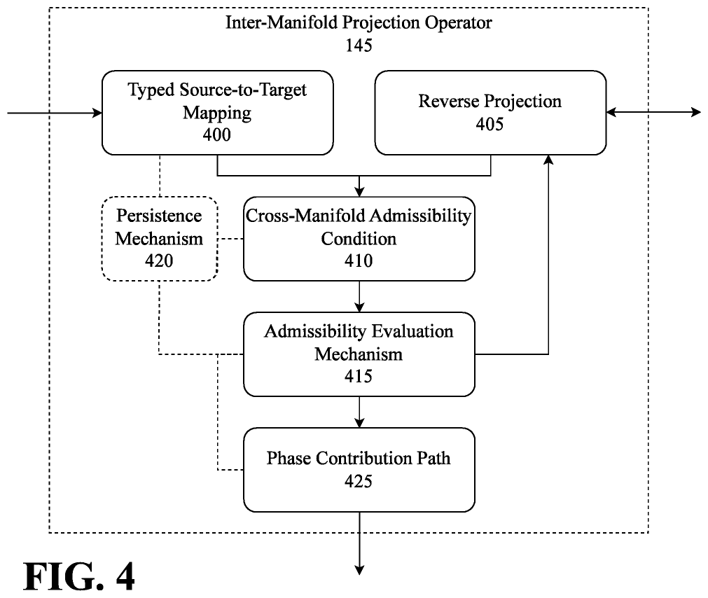

FIG. 4 is a block diagram illustrating exemplary architecture of an inter-manifold projection operator 145 of a federated manifold robotic system 100, in an embodiment.

In an embodiment, inter-manifold projection operator 145 may include a persistence structure 420, a typed source-to-target mapping 400, a reverse projection 405, a cross-manifold admissibility condition 410, an admissibility evaluation structure 415, a phase contribution path 425, and an admissibility-gated projected states output. Persistence structure 420 may maintain mapping parameters and stored configuration data across successive operation cycles such that inter-manifold projection operator 145 remains available for use in each plan-execute-perceive cycle without reinitialization. Persistence structure 420 distinguishes inter-manifold projection operator 145 from ephemeral synchronizers as disclosed in a parent application, which are transient constructs subject to mandatory dissolution upon completion of a synchronization session and are not maintained across operation cycles.

In an embodiment, typed source-to-target mapping 400 may define a mapping from a source manifold to a target manifold constrained by domain type, and may map candidate action states received from central cognitive manifold 105 into corresponding projected states within a respective peripheral manifold. In an embodiment, the mapping may comprise a differentiable or otherwise structured transformation that preserves local geometric relationships between states across manifolds. Reverse projection 405 may define a corresponding mapping from a peripheral manifold to central cognitive manifold 105, projecting sensory state representations into central cognitive manifold 105 during a perceptual update phase of a plan-execute-perceive cycle. Typed source-to-target mapping 400 and reverse projection 405 may operate as projection paths within inter-manifold projection operator 145, each providing projected states for subsequent admissibility evaluation and coherence processing.

In an embodiment, cross-manifold admissibility condition 410 may define a constraint associated with inter-manifold projection operator 145 requiring that projected states satisfy admissibility criteria of a target manifold at a projected location. Cross-manifold admissibility condition 410 may reference admissibility criteria defined within the target manifold, including boundary conditions, capacity conditions, and reservoir-induced constraints. Admissibility evaluation structure 415 may evaluate projected states against such criteria, for example by invoking or interfacing with admissibility evaluation processes of the target manifold, and may generate an admissibility determination indicating whether the projected state satisfies the required conditions. The admissibility determination may be provided to federated admissibility evaluator 150 for inclusion in conjunctive federated admissibility evaluation across affected peripheral manifolds.

Phase contribution path 425 may operate as a parallel output of inter-manifold projection operator 145, generating and transmitting transition-specific phase values associated with inter-manifold boundary crossings to cross-manifold holonomy monitor 160 for inclusion in cross-manifold coherence accumulation across a plan-execute-perceive cycle. Admissibility-gated projected states produced by admissibility evaluation structure 415 may be forwarded to affected peripheral manifolds for further processing and to central cognitive manifold 105 during perceptual update. Together, phase contribution path 425 and the admissibility-gated projected states output may provide external interfaces of inter-manifold projection operator 145 supporting both cross-manifold coherence monitoring and federated admissibility evaluation within federated manifold robotic system 100.

In an embodiment, data flow through inter-manifold projection operator 145 may proceed as follows. At an intermediate timescale, a candidate action state generated at action-selection layer 225 of central cognitive manifold 105 may be received by typed source-to-target mapping 400, which may map the candidate action state into a projected state within a target peripheral manifold. The projected state may be evaluated against cross-manifold admissibility condition 410 using admissibility evaluation structure 415, which may generate an admissibility determination based on admissibility criteria obtained from the target manifold. The admissibility determination may be provided to federated admissibility evaluator 150 for inclusion in conjunctive federated admissibility evaluation across all affected peripheral manifolds. In parallel, phase contribution path 425 may generate a transition-specific phase value associated with the inter-manifold boundary crossing and may transmit that value to cross-manifold holonomy monitor 160 for incorporation into a cross-manifold path-dependent coherence quantity accumulated across the plan-execute-perceive cycle. During a perceptual update phase following execution, reverse projection 405 may receive sensory state representations from one or more peripheral manifolds and may project those representations into central cognitive manifold 105, where they may influence admissibility boundary conditions and path-dependent coherence quantities maintained within epistemic conditioning 230. Across successive operation cycles, persistence structure 420 may maintain mapping parameters and stored configuration data such that typed source-to-target mapping 400, reverse projection 405, cross-manifold admissibility condition 410, admissibility evaluation structure 415, and phase contribution path 425 remain available for use without reinitialization.

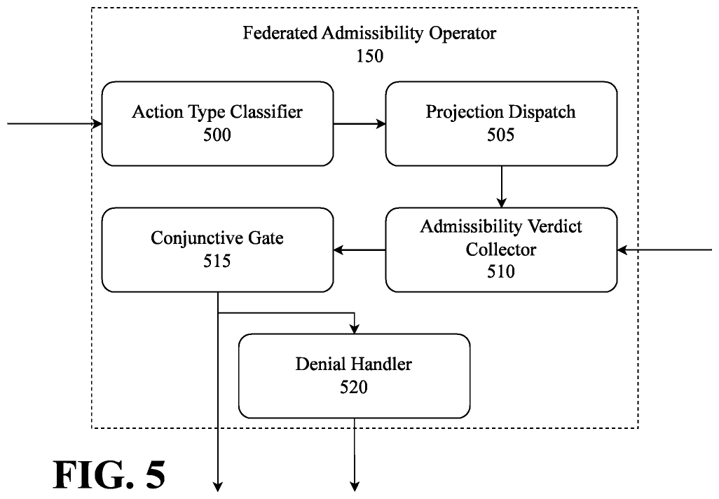

FIG. 5 is a block diagram illustrating exemplary architecture of a federated admissibility evaluator 150 of a federated manifold robotic system 100, in an embodiment.

In an embodiment, federated admissibility evaluator 150 may include an action type classifier 500, a projection coordination structure 505, an admissibility verdict collector 510, a conjunctive gate 515, a denial handler 520, and an approval output interface. Federated admissibility evaluator 150 may receive candidate actions from central cognitive manifold 105 and may be configured to determine whether each candidate action is simultaneously epistemically admissible across all peripheral manifolds affected by that action prior to permitting formation or execution of a corresponding action trajectory. Federated admissibility evaluator 150 may provide a conjunctive gating function within federated manifold robotic system 100 such that a candidate action proceeds to execution only when admissibility is satisfied in each affected peripheral manifold, thereby preventing execution of actions that are inconsistent across sensorimotor domains.

In an embodiment, action type classifier 500 may receive a candidate action from central cognitive manifold 105 and may determine a set of peripheral manifolds affected by that candidate action based on characteristics or metadata associated with the action. For example, a motion command affecting configuration of a controlled system may determine a set including at least motor configuration manifold 120 and spatial world model manifold 135. A grasping or contact command may determine a set that additionally includes haptic manifold 130. An utterance or linguistic command may determine a set including language manifold 140. Action type classifier 500 may provide the determined set of affected peripheral manifolds together with the candidate action to projection coordination structure 505.

In an embodiment, projection coordination structure 505 may receive the candidate action and the set of affected peripheral manifolds from action type classifier 500 and may invoke corresponding inter-manifold projection operators 145 to generate projected action states within each affected peripheral manifold. Projection coordination structure 505 may transmit projected action states to each affected peripheral manifold through corresponding inter-manifold projection operators 145, where each projected action state may be evaluated for epistemic admissibility based on structural properties of the receiving manifold, including, for example, admissibility boundary conditions, capacity constraints, degeneracy conditions, and reservoir-induced constraints. Admissibility determinations generated by each affected peripheral manifold may be returned to admissibility verdict collector 510.

In an embodiment, admissibility verdict collector 510 may receive and aggregate admissibility determinations from each affected peripheral manifold and may provide the aggregated determinations to conjunctive gate 515. Conjunctive gate 515 may determine that federated admissibility is satisfied when all received admissibility determinations are positive, and may determine that federated admissibility is not satisfied when any received admissibility determination indicates a denial. Based on this determination, conjunctive gate 515 may provide either a positive determination to approval output interface or a negative determination to denial handler 520.

In an embodiment, denial handler 520 may receive a negative determination from conjunctive gate 515 together with information identifying a peripheral manifold in which admissibility was not satisfied and information characterizing the admissibility failure, such as violation of a boundary condition, capacity constraint, or reservoir-induced restriction. Denial handler 520 may provide such information to planning sub-manifold 115 to guide generation of an alternative candidate action that avoids action-selection states associated with inadmissible projected states. When no admissible alternative candidate action is available, denial handler 520 may provide information to intentional sub-manifold 110 for revision of goal states 200 or priority structure 210. Approval output interface may transmit a positive federated admissibility determination together with the candidate action to geodesic trajectory planner 155, which may compute a geodesic trajectory through motor configuration manifold 120 for execution.

In an embodiment, data flow through federated admissibility evaluator 150 may proceed as follows. A candidate action generated at action-selection layer 225 of central cognitive manifold 105 may be received by action type classifier 500, which may determine a set of affected peripheral manifolds and provide that set together with the candidate action to projection coordination structure 505. Projection coordination structure 505 may invoke inter-manifold projection operators 145 corresponding to each affected peripheral manifold to generate projected action states, and those projected action states may be evaluated within the respective peripheral manifolds according to admissibility criteria defined by those manifolds. Admissibility determinations may be returned to admissibility verdict collector 510, which may aggregate the determinations and provide them to conjunctive gate 515. Conjunctive gate 515 may determine whether all affected peripheral manifolds have returned positive determinations. Upon a positive determination, approval output interface may transmit the candidate action to geodesic trajectory planner 155, which may initiate geodesic trajectory computation through motor configuration manifold 120. Upon a negative determination, denial handler 520 may provide information regarding the admissibility failure to planning sub-manifold 115, which may compute an alternative reasoning trajectory that avoids inadmissible action-selection states, and an alternative candidate action may be resubmitted to federated admissibility evaluator 150 for evaluation.

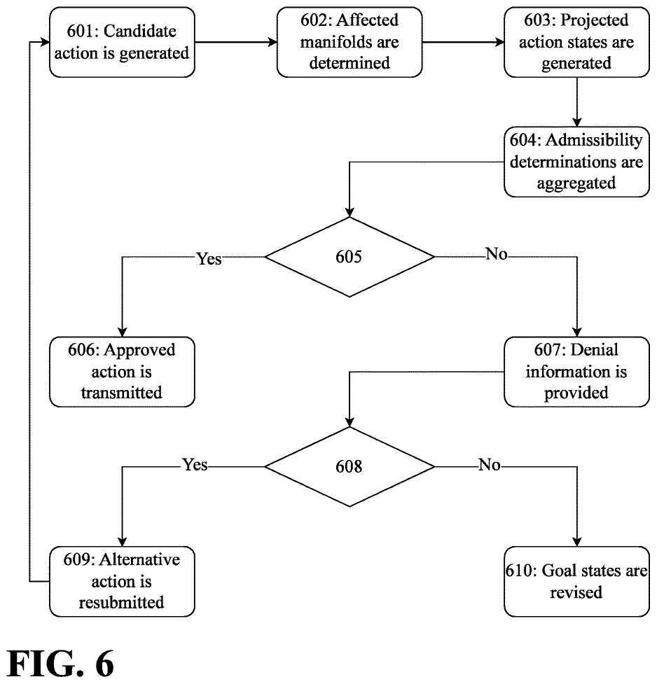

FIG. 6 is a flow diagram illustrating exemplary federated admissibility evaluation process within a federated robotic manifold system 100, in an embodiment.

The federated admissibility evaluation process may begin when action-selection layer 225 of central cognitive manifold 105 generates a candidate action and forwards it to federated admissibility evaluator 150 for evaluation prior to execution 601. Action type classifier 500 of federated admissibility evaluator 150 may receive the candidate action and may determine a set of peripheral manifolds affected by that action based on the type or characteristics of the candidate action, such that a motion command may determine a set including at least motor configuration manifold 120 and spatial world model manifold 135, a grasping or contact command may additionally include haptic manifold 130, and a linguistic command may include language manifold 140 602. Projection dispatch 505 of federated admissibility evaluator 150 may cause generation of a projected action state in each affected peripheral manifold by invoking corresponding inter-manifold projection operators 145 to map the candidate action into a projected state within each respective manifold 603. Admissibility verdict collector 510 of federated admissibility evaluator 150 may receive and aggregate admissibility determinations generated within each respective peripheral manifold, wherein each projected action state is evaluated for epistemic admissibility within the corresponding manifold based on structural properties of that manifold, including, for example, admissibility boundary conditions, capacity constraints, degeneracy conditions, and compatibility with path-dependent descriptors 604.

Conjunctive gate 515 of federated admissibility evaluator 150 may determine whether epistemic admissibility is satisfied in every affected peripheral manifold, such that federated admissibility is determined to be satisfied if and only if each affected peripheral manifold provides a positive admissibility determination 605. When conjunctive gate 515 determines that federated admissibility is satisfied, federated admissibility evaluator 150 may transmit an approval signal together with the candidate action to geodesic trajectory planner 155 for computation of an action trajectory through motor configuration manifold 120 606. When conjunctive gate 515 determines that federated admissibility is not satisfied in one or more affected peripheral manifolds, federated admissibility evaluator 150 may deny execution of the candidate action and denial handler 520 may provide information identifying the peripheral manifold in which admissibility was not satisfied and information characterizing the admissibility failure, such as a boundary violation, capacity constraint, or reservoir-induced restriction, to planning sub-manifold Mp 115 607. Planning sub-manifold Mp 115 may evaluate whether an alternative candidate action is available by determining whether a reasoning trajectory exists that avoids action-selection states whose projected states were found inadmissible in one or more affected peripheral manifolds 608. When an alternative candidate action is available, planning sub-manifold Mp 115 may generate an alternative candidate action along a reasoning trajectory that avoids the inadmissible action-selection states identified in step 607, and the alternative candidate action may be resubmitted to federated admissibility evaluator 150 at step 601 for evaluation 609. When no alternative candidate action is available, planning sub-manifold Mp 115 may provide information indicating the admissibility failure to intentional sub-manifold Mi 110, which may revise goal states 200 or priority structure 210 in response to the reported failure 610.

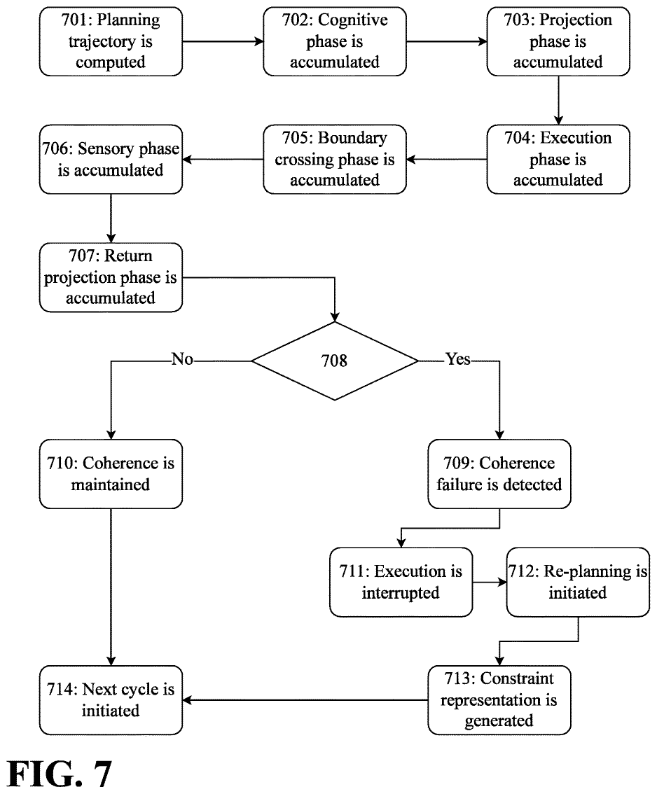

FIG. 7 is a flow diagram illustrating exemplary cross-manifold holonomy monitoring during a plan-execute-perceive cycle within a federated manifold robotic system 100, in an embodiment.

The cross-manifold holonomy monitoring process may begin when central cognitive manifold 105 initiates a plan-execute-perceive cycle by computing a planning trajectory through planning sub-manifold Mp 115 from a goal state in intentional sub-manifold Mi 110 to an action-selection state 701. Cross-manifold holonomy monitor 160 may accumulate cross-manifold phase contributions from traversal within central cognitive manifold 105 by combining transition-specific coherence values assigned by an epistemic connection of central cognitive manifold 105 to transitions along the planning trajectory, thereby contributing to a cross-manifold path-dependent coherence quantity 702. Upon transition from central cognitive manifold 105 to motor configuration manifold 120 via inter-manifold projection operator 145, cross-manifold holonomy monitor 160 may accumulate an additional phase contribution associated with that inter-manifold boundary crossing, for example as provided by phase contribution path 425 of inter-manifold projection operator 145 703. Cross-manifold holonomy monitor 160 may accumulate phase contributions from traversal of motor configuration manifold 120 during execution of an action trajectory, wherein the trajectory is computed by geodesic trajectory planner 155 and executed via an actuator interface, and may incorporate those contributions into the cross-manifold path-dependent coherence quantity 704.

Upon transition from motor configuration manifold 120 to one or more sensory peripheral manifolds via inter-manifold projection operators 145, cross-manifold holonomy monitor 160 may accumulate phase contributions associated with each inter-manifold boundary crossing, for example as provided by phase contribution path 425 of corresponding inter-manifold projection operators 145 705. Cross-manifold holonomy monitor 160 may accumulate phase contributions from perceptual update traversal within sensory peripheral manifolds, such as visual manifold 125, haptic manifold 130, and spatial world model manifold 135, following execution of the action trajectory 706. Inter-manifold projection operators 145 may project updated sensory state representations from sensory peripheral manifolds into central cognitive manifold 105, and cross-manifold holonomy monitor 160 may accumulate phase contributions associated with those projection transitions into the cross-manifold path-dependent coherence quantity 707. Cross-manifold holonomy monitor 160 may determine whether a cross-manifold phase discontinuity is present at any inter-manifold transition during the current cycle by evaluating whether a change in the cross-manifold path-dependent coherence quantity at an inter-manifold transition exceeds a discontinuity threshold, wherein the threshold may be defined based on deviation from expected phase accumulation 708.

When a cross-manifold phase discontinuity exceeding the discontinuity threshold is detected, cross-manifold holonomy monitor 160 may determine that a cross-manifold coherence failure condition exists and may issue an intervention signal indicating a mismatch between a planned trajectory and an observed execution outcome 709. When no cross-manifold phase discontinuity exceeding the discontinuity threshold is detected, cross-manifold holonomy monitor 160 may determine that cross-manifold epistemic coherence is maintained 710. Upon issuing an intervention signal at step 709, cross-manifold holonomy monitor 160 may signal reactive safety layer 165 to interrupt a current action trajectory within motor configuration manifold 120 711. Cross-manifold holonomy monitor 160 may initiate a re-planning cycle in central cognitive manifold 105 by forwarding a coherence failure signal to planning sub-manifold Mp 115, which may compute a revised reasoning trajectory that avoids action-selection states associated with the detected discontinuity 712. Reservoir formation and consolidation process 170, responsive to the intervention signal from cross-manifold holonomy monitor 160, may generate a constraint representation characterizing the detected cross-manifold phase discontinuity, for example based on structural deviation across manifolds, and may project that representation into irreversible reservoirs of a peripheral manifold in which the discontinuity was localized 713. Upon completion of the intervention steps at steps 711 through 713 or upon determination that coherence is maintained at step 710, federated manifold robotic system 100 may return to a subsequent plan-execute-perceive cycle and federated admissibility evaluation may be resumed at step 601 714.

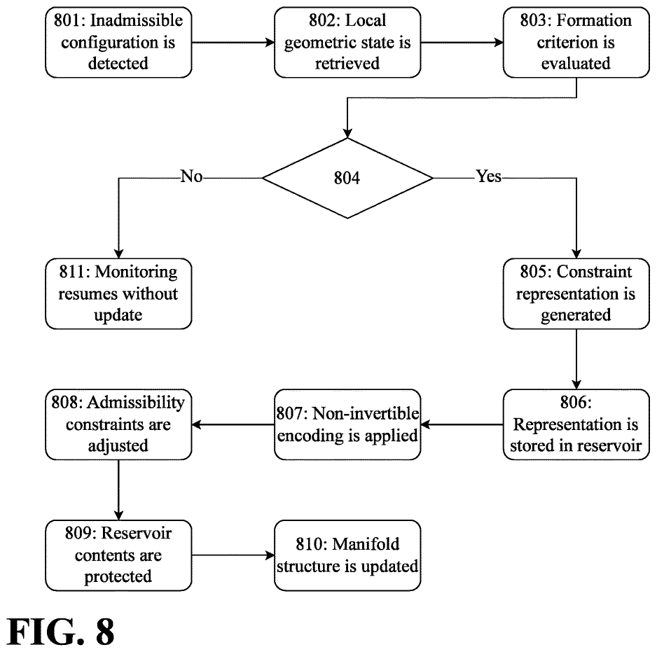

FIG. 8 is a flow diagram illustrating exemplary irreversible collision reservoir formation within a motor configuration manifold 120 of a federated manifold robotic system 100, in an embodiment.

The irreversible collision reservoir formation process may begin when an inadmissible configuration is detected during execution within motor configuration manifold 120, for example by reactive safety layer 165 performing a fast-timescale admissibility evaluation of current joint states against admissibility boundaries and reservoir-derived constraints, or by federated admissibility evaluator 150 evaluating a projected action state during a federated admissibility evaluation 801. Reservoir formation and consolidation process 170 may retrieve a geometric state of a configuration-space region associated with the inadmissible configuration from motor configuration manifold 120, thereby providing local geometric context for constraint representation generation 802. Reservoir formation and consolidation process 170 may evaluate a three-condition formation criterion comprising: a determination that phase flatness of the configuration-space region is below a flatness threshold, wherein phase flatness may correspond to local variation of accumulated coherence values; a determination that boundary energy of the region is above a barrier threshold, wherein boundary energy may correspond to a measure of constraint intensity derived from proximity to admissibility boundaries; and a determination that boundary-aware admission control routing is compatible with reservoir insertion for the detected inadmissible configuration 803.

Reservoir formation and consolidation process 170 may determine whether the three-condition formation criterion is satisfied, branching to constraint representation generation when the criterion is satisfied and returning to execution monitoring without a reservoir update when the criterion is not satisfied 804. When the formation criterion is satisfied, reservoir formation and consolidation process 170 may generate a constraint representation encoding a curvature signature of a neighborhood of the inadmissible configuration, wherein the curvature signature may be derived from local geometric properties such as variation of a Riemannian metric or conditioning of a Jacobian, rather than explicit configuration coordinates, such that the constraint representation characterizes structural properties of the region rather than its absolute location within configuration space 805. Reservoir formation and consolidation process 170 may store the constraint representation in one or more irreversible reservoirs within motor configuration manifold 120 through a non-invertible operation 806. The non-invertible operation may include, for example, a projection or dimensionality reduction that discards reconstructable geometric details of the inadmissible configuration while preserving structural pattern information sufficient to identify configurations that are geometrically similar to the inadmissible configuration in subsequent admissibility evaluations throughout motor configuration manifold 120 807. Asymmetric constraint feedback 310b of irreversible collision reservoir structures 310 may apply constraint-based modifications to subsequent admissibility evaluations within motor configuration manifold 120, for example by adjusting effective admissibility thresholds or boundary conditions for configurations that are structurally similar to the inadmissible configuration 808. Reservoir formation and consolidation process 170 may enforce a read-only constraint on contents of irreversible collision reservoir structures 310, such that active execution processes operating within motor configuration manifold 120 do not modify stored constraint representations 809. Reservoir formation and consolidation process 170 may forward a reservoir formation event to a manifold geometric evolution process associated with motor configuration manifold 120 for incorporation into ongoing manifold structure updates, such that geometric structures of motor configuration manifold 120 may evolve to reflect updated reservoir content at a slow consolidation timescale 810. When the formation criterion evaluated at step 804 is not satisfied, reservoir formation and consolidation process 170 may determine that the detected inadmissible configuration does not meet conditions for reservoir formation and may return to execution monitoring within motor configuration manifold 120 without performing a reservoir update 811.

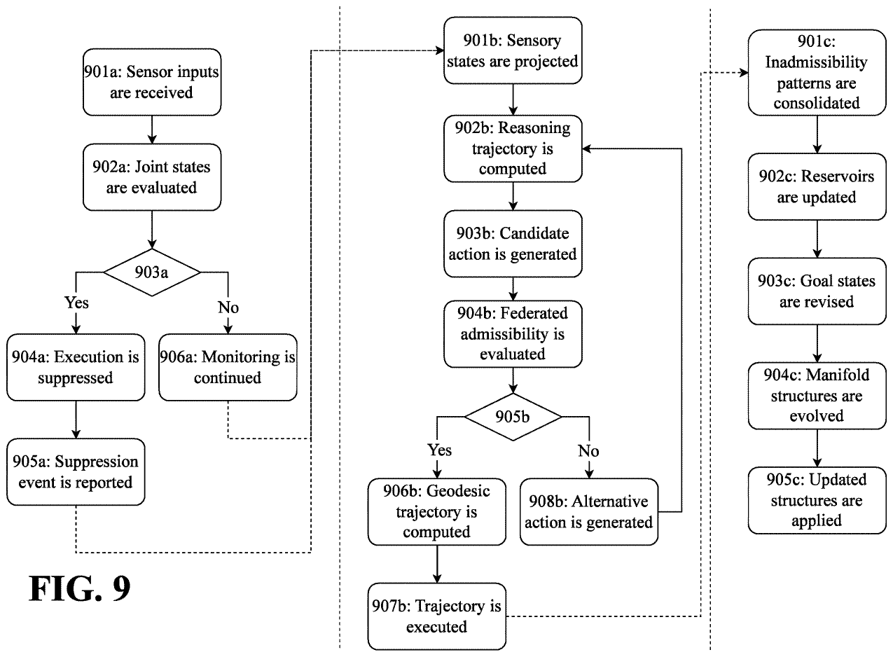

FIG. 9 is a flow diagram illustrating exemplary multi-timescale operation of a federated manifold robotic system 100, in an embodiment. The diagram illustrates three parallel operational lanes corresponding to a fast timescale, an intermediate timescale, and a slow timescale, each operating concurrently and, in an embodiment, asynchronously while exchanging information across federated manifold robotic system 100.

At the fast timescale, corresponding to a sensor update rate on the order of one to ten milliseconds, peripheral manifolds comprising visual manifold 125, haptic manifold 130, and motor configuration manifold 120 may receive projection updates from sensor inputs including joint state measurements, visual observations, and force and torque measurements 901a. Reactive safety layer 165 may evaluate current joint states against admissibility boundaries and reservoir-derived constraints encoded within motor configuration manifold 120, performing a lightweight admissibility evaluation at sensor rate without requiring processing by central cognitive manifold 105 902a. Reactive safety layer 165 may determine whether an admissibility failure is present, branching to execution suppression when a failure is detected and continuing trajectory execution when no failure is detected 903a. Upon detecting an admissibility failure, reactive safety layer 165 may suppress execution of a current trajectory segment and may issue a halt signal directly to a robot actuator interface without waiting for central cognitive manifold 105 to process the event 904a. Reactive safety layer 165 may provide a notification of the suppression event to central cognitive manifold 105 for subsequent re-planning at the intermediate timescale 905a. When no admissibility failure is detected, reactive safety layer 165 may continue monitoring execution and proceed to evaluate a subsequent sensor update cycle 906a.

At the intermediate timescale, corresponding to a reasoning rate on the order of fifty to five hundred milliseconds, sensory state representations that satisfy admissibility conditions within peripheral manifolds may be projected through inter-manifold projection operators 145 to central cognitive manifold 105, where they may influence admissibility boundary conditions and path-dependent coherence quantities maintained within epistemic conditioning 230 901b. Planning sub-manifold Mp 115 may compute a reasoning trajectory originating from a goal state in intentional sub-manifold Mi 110 and terminating at an action-selection state, subject to admissibility and coherence conditions encoded within central cognitive manifold 105 902b. Action-selection layer 225 may generate a candidate action from an admitted reasoning trajectory and may forward the candidate action to federated admissibility evaluator 150 for evaluation prior to execution 903b. Federated admissibility evaluator 150 may evaluate federated admissibility of the candidate action by causing projection of the action into each affected peripheral manifold via inter-manifold projection operators 145 and receiving admissibility determinations from each affected manifold 904b. Conjunctive gate 515 of federated admissibility evaluator 150 may determine whether federated admissibility is satisfied across all affected peripheral manifolds, branching to trajectory computation when satisfied and to denial handling when not satisfied 905b. Upon a positive federated admissibility determination, geodesic trajectory planner 155 may compute a geodesic path through motor configuration manifold 120 from an admitted start configuration to a goal configuration satisfying admissibility boundaries and reservoir-derived constraints 906b. The computed geodesic trajectory may be issued to a robot actuator interface for execution 907b. Upon a negative federated admissibility determination, denial handler 520 may provide information characterizing the admissibility failure to planning sub-manifold Mp 115, which may compute a revised reasoning trajectory avoiding inadmissible action-selection states, and a revised candidate action may be resubmitted for evaluation at step 902b 908b.

At the slow timescale, corresponding to a consolidation rate on the order of seconds to minutes, reservoir formation and consolidation process 170 may consolidate accumulated inadmissibility patterns derived from inadmissibility events recorded across prior operation cycles within manifolds of federated manifold robotic system 100 901c. Irreversible reservoirs within peripheral manifolds including motor configuration manifold 120, visual manifold 125, haptic manifold 130, and spatial world model manifold 135 may be updated with consolidated constraint representations generated by reservoir formation and consolidation process 170 902c. Intentional sub-manifold Mi 110 may review and revise goal states 200 and priority structure 210 to reflect updated task priorities, environmental model changes, or admissibility failures reported by planning sub-manifold Mp 115 during prior intermediate-timescale operation cycles 903c. Manifold geometric structures across manifolds of federated manifold robotic system 100 may evolve under compression and connection relaxation flows inherited from a persistent cognitive machine architecture, wherein such flows may include geometric smoothing, constraint redistribution, or connection adjustment processes that incorporate reservoir formation events forwarded by reservoir formation and consolidation process 170 904c. Updated reservoir content and evolved manifold geometric structures may be made available for subsequent admissibility evaluations at the fast and intermediate timescales, such that accumulated safety learning from prior operation cycles may influence future admissibility determinations across federated manifold robotic system 100 905c.

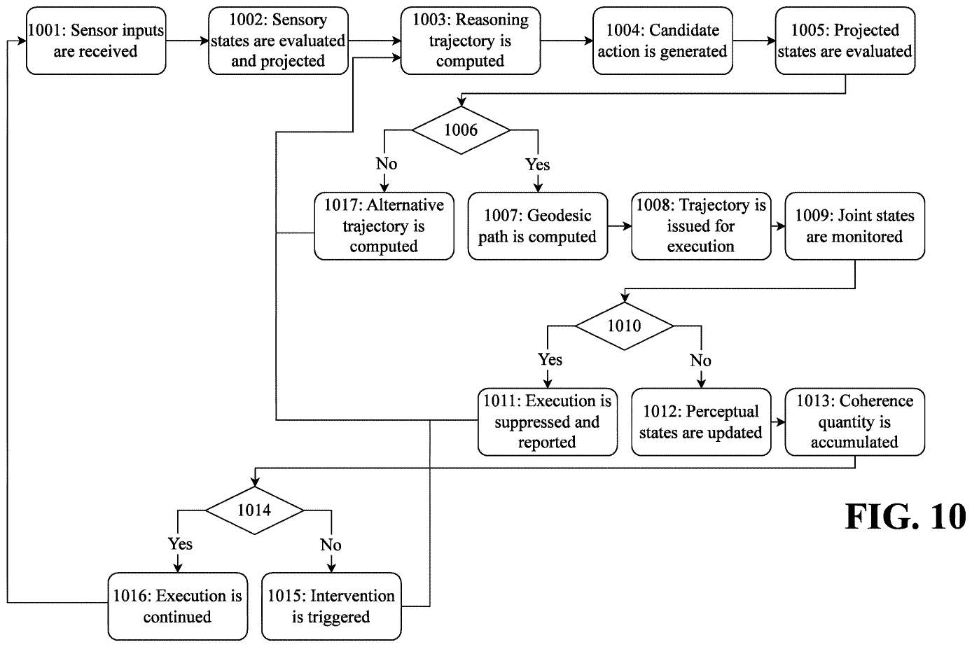

FIG. 10 is a flow diagram illustrating exemplary end-to-end data flow through a federated manifold robotic system 100, in an embodiment.

The end-to-end data flow process may begin when sensor inputs arrive at respective peripheral manifolds, comprising joint state measurements arriving at motor configuration manifold 120, visual observations arriving at visual manifold 125, and force and torque measurements arriving at haptic manifold 130 1001. Each peripheral manifold may evaluate incoming sensor inputs for epistemic admissibility based on structural properties of that manifold, and sensory state representations that satisfy admissibility conditions may be forwarded through inter-manifold projection operators 145 to central cognitive manifold 105 at an intermediate timescale 1002. Planning sub-manifold Mp 115 of central cognitive manifold 105 may compute a reasoning trajectory originating from a goal state in intentional sub-manifold Mi 110 and terminating at an action-selection state, subject to admissibility and coherence conditions encoded within central cognitive manifold 105 1003. Action-selection layer 225 of central cognitive manifold 105 may generate a candidate action from an admitted reasoning trajectory and may forward the candidate action to federated admissibility evaluator 150 for evaluation prior to execution 1004. Federated admissibility evaluator 150 may cause projection of the candidate action into each affected peripheral manifold by invoking corresponding inter-manifold projection operators 145 to generate projected action states, and admissibility determinations generated within each affected manifold may be aggregated by admissibility verdict collector 510 1005.

Conjunctive gate 515 of federated admissibility evaluator 150 may determine whether federated admissibility is satisfied across all affected peripheral manifolds, branching to geodesic trajectory computation when satisfied and to denial handling when not satisfied 1006. Upon a positive federated admissibility determination, geodesic trajectory planner 155 may compute a geodesic path through motor configuration manifold 120 from an admitted start configuration to a goal configuration satisfying admissibility boundaries and reservoir-derived constraints of motor configuration manifold 120 1007. The computed geodesic trajectory may be issued to a robot actuator interface for execution 1008. Concurrently with execution of the trajectory, reactive safety layer 165 may monitor current joint states against admissibility boundaries and reservoir-derived constraints within motor configuration manifold 120 at a fast timescale, evaluating each sensor update independently of central cognitive manifold 105 1009. Reactive safety layer 165 may determine whether a reactive admissibility failure is present, branching to execution suppression when a failure is detected and continuing to perceptual update when no failure is detected 1010. Upon detecting a reactive admissibility failure, reactive safety layer 165 may suppress execution of a current trajectory segment, may issue a halt signal to the robot actuator interface, and may notify central cognitive manifold 105 of the suppression event, causing planning sub-manifold Mp 115 to initiate a revised reasoning trajectory at step 1003 1011. When no reactive admissibility failure is detected, sensory peripheral manifolds comprising visual manifold 125, haptic manifold 130, and spatial world model manifold 135 may receive perceptual update projections following execution, updating geometric states to reflect an outcome of the executed trajectory 1012. Cross-manifold holonomy monitor 160 may accumulate a cross-manifold path-dependent coherence quantity across a full plan-execute-perceive cycle, combining phase contributions from traversal within central cognitive manifold 105, motor configuration manifold 120, and sensory peripheral manifolds, and from transitions across inter-manifold projection operators 145 1013. Cross-manifold holonomy monitor 160 may determine whether a cross-manifold coherence failure condition is present by evaluating whether a change in the cross-manifold path-dependent coherence quantity at an inter-manifold transition exceeds a discontinuity threshold 1014. Upon detecting a cross-manifold coherence failure condition, cross-manifold holonomy monitor 160 may issue an intervention signal causing interruption of the current action trajectory, initiation of a re-planning cycle in planning sub-manifold Mp 115, and projection of a constraint representation characterizing the detected discontinuity into irreversible reservoirs of an affected peripheral manifold, with the re-planning cycle resuming at step 1003 1015. When cross-manifold coherence is maintained, continued actuator execution may proceed based on satisfied federated admissibility and coherence determinations, and federated manifold robotic system 100 may proceed to a subsequent plan-execute-perceive cycle at step 1001 1016. Upon a negative federated admissibility determination at step 1006, denial handler 520 may provide information identifying a peripheral manifold in which admissibility was not satisfied to planning sub-manifold Mp 115, and planning sub-manifold Mp 115 may compute a revised reasoning trajectory avoiding inadmissible action-selection states, resuming at step 1003 1017.

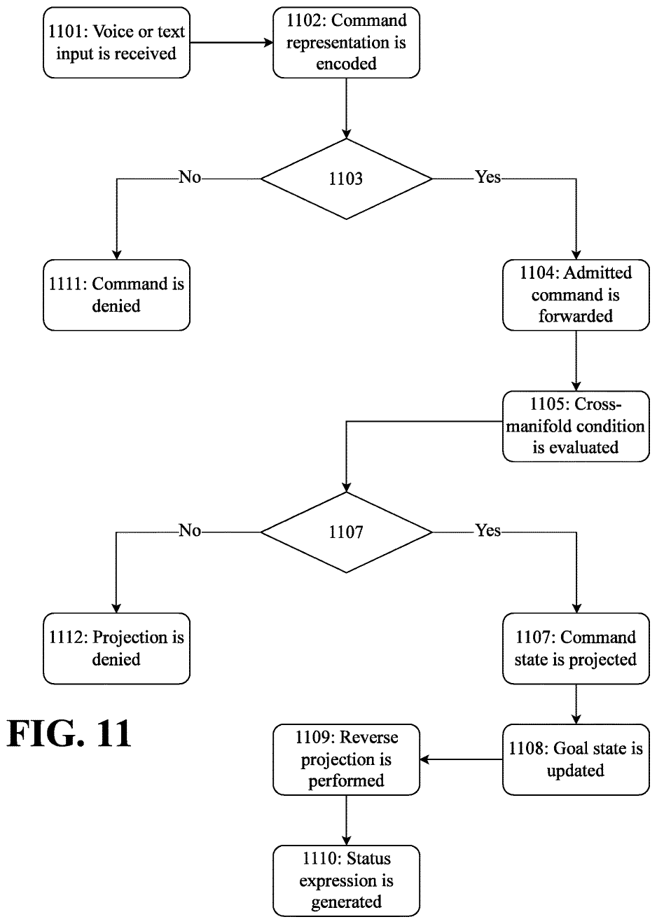

FIG. 11 is a flow diagram illustrating exemplary operation of a linguistic projection operator within a federated manifold robotic system 100, in an embodiment.

The linguistic projection operator process may begin when voice or text input is received at auditory/language manifold Ma 140, which may be configured to receive natural language commands and to represent such commands as structured representations within an epistemically conditioned geometric substrate 1101. Language manifold Ma 140 may encode a parsed command representation derived from the received voice or text input as a cognitive state within its geometric substrate, for example by mapping a semantic or symbolic representation of the command to a location within the manifold based on learned or predefined transformations 1102. Language manifold Ma 140 may evaluate epistemic admissibility of the encoded command representation based on structural properties of language manifold Ma 140, including, for example, admissibility boundary conditions and capacity constraints, branching to admission when admissibility is satisfied and to denial when admissibility is not satisfied 1103. When the command representation is determined to be admissible within language manifold Ma 140, the admitted command state may be forwarded to the linguistic projection operator for evaluation of a cross-manifold admissibility condition governing projection into intentional sub-manifold Mi 110 1104. The linguistic projection operator may evaluate cross-manifold admissibility condition 410 associated with a mapping from language manifold Ma 140 to intentional sub-manifold Mi 110, determining whether a projected command state would map to a forbidden region of intentional sub-manifold Mi 110 or conflict with committed goal states already established within intentional sub-manifold Mi 110 1105.

The linguistic projection operator may determine whether projection of the admitted command state into intentional sub-manifold Mi 110 satisfies the cross-manifold admissibility condition, branching to projection when the condition is satisfied and to denial when the condition is not satisfied 1106. When the cross-manifold admissibility condition is satisfied, the linguistic projection operator may project the admitted command state into intentional sub-manifold Mi 110 of central cognitive manifold 105 through a persistent typed mapping defined by the linguistic projection operator 1107. The projected command state may establish or revise a goal state 200 within intentional sub-manifold Mi 110, and planning sub-manifold Mp 115 may initiate a reasoning trajectory responsive to the updated goal state toward an action-selection state for federated admissibility evaluation 1108. Central cognitive manifold 105 may perform a reverse projection through the linguistic projection operator to language manifold Ma 140, generating a structured representation of a current geometric state of central cognitive manifold 105 suitable for linguistic rendering 1109. Language manifold Ma 140 may generate a verbal or textual status expression based on the structured representation, thereby providing a report corresponding to a current cognitive and planning state of the system 1110. When the command representation is determined to be inadmissible within language manifold Ma 140 at step 1103, language manifold Ma 140 may deny the command and prevent the command representation from being forwarded to the linguistic projection operator 1111. When the cross-manifold admissibility condition evaluated at step 1106 is not satisfied, the linguistic projection operator may deny projection of the command state into intentional sub-manifold Mi 110, preventing the command from influencing goal states 200 or priority structure 210 within intentional sub-manifold Mi 110 1112.

### Exemplary Computing Environment

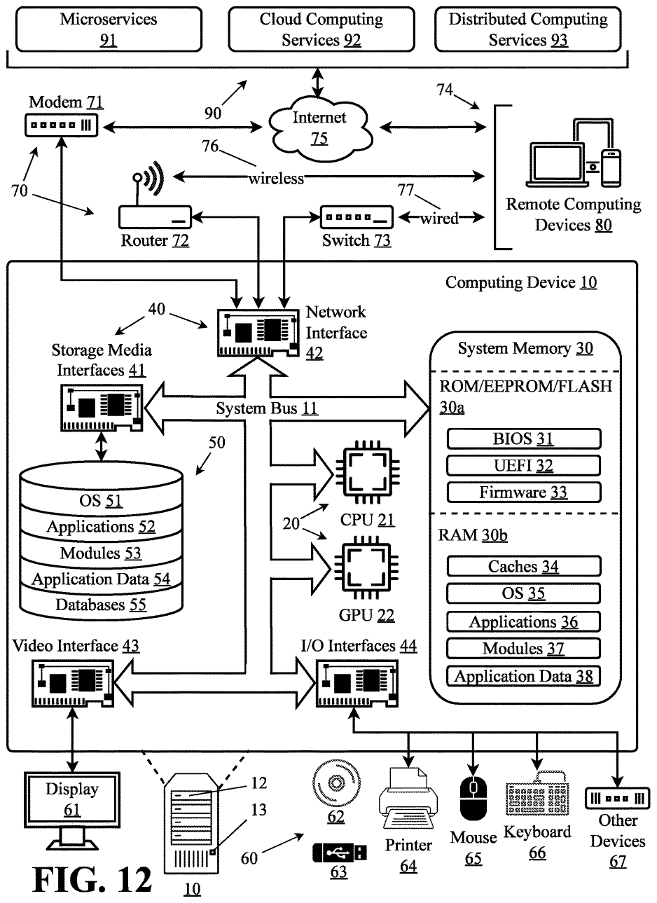

FIG. 12 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on nontransitory machine-readable storage media that:
maintain a central cognitive manifold and a plurality of peripheral manifolds as geometric substrates for cognitive operations, wherein the central cognitive manifold encodes cognitive states comprising at least intention states, planning states, and action-selection states together with epistemic conditioning information governing admissibility of reasoning trajectories within the central cognitive manifold, and wherein each peripheral manifold encodes states of a respective domain together with epistemic conditioning information governing admissibility of operations within that peripheral manifold, and wherein the plurality of peripheral manifolds comprises at least a configuration manifold encoding configuration states of a controlled system and one or more sensory peripheral manifolds encoding environmental observations;
maintain a plurality of inter-manifold projection operators, each inter-manifold projection operator defining a persistent typed mapping between the central cognitive manifold and a respective peripheral manifold, wherein each inter-manifold projection operator is maintained across successive operation cycles and carries an associated cross-manifold admissibility condition that constrains projection of states between manifolds such that projected states are required to satisfy admissibility criteria of a target manifold at a projected location;
evaluate epistemic admissibility of candidate cognitive states in the central cognitive manifold based on structural properties of the central cognitive manifold, and deny admission by preventing formation of a reasoning trajectory when epistemic admissibility is not satisfied;
compute reasoning trajectories through the central cognitive manifold from admitted cognitive states and generate a candidate action from an action-selection state reached by an admitted reasoning trajectory;
evaluate federated admissibility of the candidate action by determining a set of peripheral manifolds affected by the candidate action, computing for each affected peripheral manifold a projected action state by applying a corresponding inter-manifold projection operator to the candidate action, evaluating epistemic admissibility of each projected action state in its respective peripheral manifold based on structural properties of that peripheral manifold, and preventing formation or execution of an action trajectory corresponding to the candidate action when epistemic admissibility is not satisfied in any affected peripheral manifold;
encode constraints of the controlled system as admissibility boundaries and forbidden regions within the configuration manifold, and upon determining that a configuration encountered during execution is inadmissible, generate a constraint representation characterizing a structural property of a configuration-space region associated with the inadmissible configuration and project the constraint representation into one or more irreversible reservoirs within the configuration manifold through a non-invertible operation that discards reconstructable details of the inadmissible configuration while preserving information usable to identify structurally similar inadmissible configurations in subsequent evaluations, and apply asymmetric constraint feedback from the one or more irreversible reservoirs to subsequent admissibility evaluations within the configuration manifold, wherein active execution does not modify contents of the one or more irreversible reservoirs;
compute an action trajectory through the configuration manifold as a geodesic path from an admitted start configuration to a goal configuration that satisfies the admissibility boundaries and irreversible reservoir barriers of the configuration manifold;
monitor cross-manifold epistemic coherence during a plan-execute-perceive cycle by accumulating a cross-manifold path-dependent coherence quantity across transitions spanning the central cognitive manifold and one or more peripheral manifolds, including contributions from traversal within individual manifolds and transitions across inter-manifold projection operators, during a cycle comprising action planning in the central cognitive manifold, trajectory execution in the configuration manifold, and perceptual update in one or more sensory peripheral manifolds, and detecting a cross-manifold coherence failure condition comprising a change in the cross-manifold path-dependent coherence quantity at an inter-manifold transition that exceeds a discontinuity threshold; and
generate an output or execute an action conditioned on the federated admissibility, and suppress, qualify, or withhold the output or execution when federated admissibility is not satisfied in any affected peripheral manifold or when a cross-manifold coherence failure condition is detected.

2. The computer system of claim 1, wherein each of the central cognitive manifold and the plurality of peripheral manifolds carries a semantic metric encoding dissimilarity between states within that manifold, an almost-complex structure restricting admissible deformations of that manifold, a symplectic form reconstructed from the semantic metric and the almost-complex structure according to a compatibility relation, and an epistemic connection that is geometrically independent of the semantic metric and assigns transition-specific coherence values to transitions between states, such that two regions of a manifold that are identical under the semantic metric may exhibit different epistemic curvature values reflecting different levels of evidential support.

3. The computer system of claim 1, wherein the configuration manifold carries a Riemannian metric derived from task-space geometry of the controlled system such that distances within the configuration manifold reflect task-relevant operation costs, and wherein singularity loci of the controlled system at which a Jacobian of the controlled system is rank-deficient are encoded as degeneracy regions within the configuration manifold, and wherein the admissibility boundaries within the configuration manifold encode configuration limits of the controlled system as structural geometric features of the configuration manifold rather than as external constraint tables.

4. The computer system of claim 1, wherein the constraint representation projected into the one or more irreversible reservoirs within the configuration manifold encodes a curvature signature of a neighborhood of the inadmissible configuration rather than explicit configuration coordinates, such that asymmetric constraint feedback from the one or more irreversible reservoirs applies to configurations that are structurally similar to the inadmissible configuration throughout the configuration manifold without storing or reconstructing the coordinates of the inadmissible configuration.

5. The computer system of claim 1, wherein the software instructions further perform, at a fast timescale corresponding to a sensor update rate, a reactive admissibility evaluation of current configuration states directly within the configuration manifold against the admissibility boundaries and irreversible reservoir barriers of the configuration manifold, and suppress execution of a current action trajectory upon detecting that a current configuration state fails the reactive admissibility evaluation without requiring processing by the central cognitive manifold, and wherein the reactive admissibility evaluation operates at a rate faster than the rate at which the central cognitive manifold computes reasoning trajectories.

6. The computer system of claim 1, wherein the central cognitive manifold carries an intentional sub-manifold encoding goal states, task context, and priority structure that evolve on a slow timescale and are structurally isolated from fast-timescale perturbations by the epistemic conditioning of the central cognitive manifold, and wherein conflicting goal states that are mutually inadmissible due to capacity or admissibility constraints within the intentional sub-manifold generate a degeneracy indicator within the intentional sub-manifold, and wherein reasoning trajectories in the central cognitive manifold originate from goal states in the intentional sub-manifold and terminate at action-selection states from which candidate actions are projected to peripheral manifolds for federated admissibility evaluation.

7. The computer system of claim 1, wherein the one or more sensory peripheral manifolds comprise a visual manifold encoding three-dimensional environmental observations and carrying admissibility boundaries corresponding to detected obstacles and irreversible reservoirs encoding learned visual hazard patterns, and a spatial world model manifold encoding a persistent geometric model of an operating environment of the controlled system, wherein the spatial world model manifold is updated by projection from the visual manifold and carries admissibility boundaries corresponding to obstacle-occupied regions derived from accumulated environmental observations.

8. The computer system of claim 1, wherein the one or more sensory peripheral manifolds further comprise a haptic manifold encoding force and torque states at an end effector of the controlled system and carrying admissibility boundaries corresponding to force overload conditions, and wherein the set of peripheral manifolds affected by a candidate action that involves end-effector contact includes the haptic manifold, such that federated admissibility evaluation of a contact action requires the projected action state to be epistemically admissible within the haptic manifold.

9. The computer system of claim 1, wherein upon detecting a cross-manifold coherence failure condition the software instructions perform at least one of interrupting a current action trajectory in the configuration manifold, initiating a re-planning cycle in the central cognitive manifold, or generating a constraint representation characterizing the detected cross-manifold phase discontinuity and projecting the constraint representation into the irreversible reservoirs of the peripheral manifold in which the discontinuity was localized, and wherein the inter-manifold projection operators through which the cross-manifold path-dependent coherence quantity is accumulated are the same persistent typed mappings used for federated admissibility evaluation, rather than ephemeral structures having bounded lifetimes.

10. The computer system of claim 1, wherein the plurality of peripheral manifolds further comprises a language manifold encoding command representations derived from voice or text input, and wherein a linguistic projection operator defines a persistent typed mapping from the language manifold to an intentional sub-manifold of the central cognitive manifold, and wherein the linguistic projection operator carries an admissibility condition that denies mapping of a command representation that would project to a forbidden region of the intentional sub-manifold or that conflicts with committed goal states within the intentional sub-manifold, and wherein reverse projection from the central cognitive manifold through the linguistic projection operator to the language manifold generates verbal or textual status expressions that are consistent with the current geometric state of the central cognitive manifold.

11. A method performed by a computer system comprising a hardware memory, the method comprising:
maintaining a central cognitive manifold and a plurality of peripheral manifolds as geometric substrates for cognitive operations, wherein the central cognitive manifold encodes cognitive states comprising at least intention states, planning states, and action-selection states together with epistemic conditioning information governing admissibility of reasoning trajectories within the central cognitive manifold, and wherein each peripheral manifold encodes states of a respective domain together with epistemic conditioning information governing admissibility of operations within that peripheral manifold, and wherein the plurality of peripheral manifolds comprises at least a configuration manifold encoding configuration states of a controlled system and one or more sensory peripheral manifolds encoding environmental observations;
maintaining a plurality of inter-manifold projection operators, each inter-manifold projection operator defining a persistent typed mapping between the central cognitive manifold and a respective peripheral manifold, wherein each inter-manifold projection operator is maintained across successive operation cycles and carries an associated cross-manifold admissibility condition that constrains projection of states between manifolds such that projected states are required to satisfy admissibility criteria of a target manifold at a projected location;
evaluating epistemic admissibility of candidate cognitive states in the central cognitive manifold based on structural properties of the central cognitive manifold, and denying admission by preventing formation of a reasoning trajectory when epistemic admissibility is not satisfied;
computing reasoning trajectories through the central cognitive manifold from admitted cognitive states and generating a candidate action from an action-selection state reached by an admitted reasoning trajectory;
evaluating federated admissibility of the candidate action by determining a set of peripheral manifolds affected by the candidate action, computing for each affected peripheral manifold a projected action state by applying a corresponding inter-manifold projection operator to the candidate action, evaluating epistemic admissibility of each projected action state in its respective peripheral manifold based on structural properties of that peripheral manifold, and preventing formation or execution of an action trajectory corresponding to the candidate action when epistemic admissibility is not satisfied in any affected peripheral manifold;
encoding constraints of the controlled system as admissibility boundaries and forbidden regions within the configuration manifold, and upon determining that a configuration encountered during execution is inadmissible, generating a constraint representation characterizing a structural property of a configuration-space region associated with the inadmissible configuration and projecting the constraint representation into one or more irreversible reservoirs within the configuration manifold through a non-invertible operation that discards reconstructable details of the inadmissible configuration while preserving information usable to identify structurally similar inadmissible configurations in subsequent evaluations, and applying asymmetric constraint feedback from the one or more irreversible reservoirs to subsequent admissibility evaluations within the configuration manifold, wherein active execution does not modify contents of the one or more irreversible reservoirs;
computing an action trajectory through the configuration manifold as a geodesic path from an admitted start configuration to a goal configuration that satisfies the admissibility boundaries and irreversible reservoir barriers of the configuration manifold;
monitoring cross-manifold epistemic coherence during a plan-execute-perceive cycle by accumulating a cross-manifold path-dependent coherence quantity across transitions spanning the central cognitive manifold and one or more peripheral manifolds, including contributions from traversal within individual manifolds and transitions across inter-manifold projection operators, during a cycle comprising action planning in the central cognitive manifold, trajectory execution in the configuration manifold, and perceptual update in one or more sensory peripheral manifolds, and detecting a cross-manifold coherence failure condition comprising a change in the cross-manifold path-dependent coherence quantity at an inter-manifold transition that exceeds a discontinuity threshold; and
generating an output or executing an action conditioned on the federated admissibility, and suppressing, qualifying, or withholding the output or execution when federated admissibility is not satisfied in any affected peripheral manifold or when a cross-manifold coherence failure condition is detected.

12. The method of claim 11, wherein each of the central cognitive manifold and the plurality of peripheral manifolds carries a semantic metric encoding dissimilarity between states within that manifold, an almost-complex structure restricting admissible deformations of that manifold, a symplectic form reconstructed from the semantic metric and the almost-complex structure according to a compatibility relation, and an epistemic connection that is geometrically independent of the semantic metric and assigns transition-specific coherence values to transitions between states, such that two regions of a manifold that are identical under the semantic metric may exhibit different epistemic curvature values reflecting different levels of evidential support.

13. The method of claim 11, wherein the configuration manifold carries a Riemannian metric derived from task-space geometry of the controlled system such that distances within the configuration manifold reflect task-relevant operation costs, and wherein singularity loci of the controlled system at which a Jacobian of the controlled system is rank-deficient are encoded as degeneracy regions within the configuration manifold, and wherein the admissibility boundaries within the configuration manifold encode configuration limits of the controlled system as structural geometric features of the configuration manifold rather than as external constraint tables.

14. The method of claim 11, wherein the constraint representation projected into the one or more irreversible reservoirs within the configuration manifold encodes a curvature signature of a neighborhood of the inadmissible configuration rather than explicit configuration coordinates, such that asymmetric constraint feedback from the one or more irreversible reservoirs applies to configurations that are structurally similar to the inadmissible configuration throughout the configuration manifold without storing or reconstructing the coordinates of the inadmissible configuration.

15. The method of claim 11, further comprising performing, at a fast timescale corresponding to a sensor update rate, a reactive admissibility evaluation of current configuration states directly within the configuration manifold against the admissibility boundaries and irreversible reservoir barriers of the configuration manifold, and suppressing execution of a current action trajectory upon detecting that a current configuration state fails the reactive admissibility evaluation without requiring processing by the central cognitive manifold, and wherein the reactive admissibility evaluation operates at a rate faster than the rate at which the central cognitive manifold computes reasoning trajectories.

16. The method of claim 11, wherein the central cognitive manifold carries an intentional sub-manifold encoding goal states, task context, and priority structure that evolve on a slow timescale and are structurally isolated from fast-timescale perturbations by the epistemic conditioning of the central cognitive manifold, and wherein conflicting goal states that are mutually inadmissible due to capacity or admissibility constraints within the intentional sub-manifold generate a degeneracy indicator within the intentional sub-manifold, and wherein reasoning trajectories in the central cognitive manifold originate from goal states in the intentional sub-manifold and terminate at action-selection states from which candidate actions are projected to peripheral manifolds for federated admissibility evaluation.

17. The method of claim 11, wherein the one or more sensory peripheral manifolds comprise a visual manifold encoding three-dimensional environmental observations and carrying admissibility boundaries corresponding to detected obstacles and irreversible reservoirs encoding learned visual hazard patterns, and a spatial world model manifold encoding a persistent geometric model of an operating environment of the controlled system, wherein the spatial world model manifold is updated by projection from the visual manifold and carries admissibility boundaries corresponding to obstacle-occupied regions derived from accumulated environmental observations.

18. The method of claim 11, wherein the one or more sensory peripheral manifolds further comprise a haptic manifold encoding force and torque states at an end effector of the controlled system and carrying admissibility boundaries corresponding to force overload conditions, and wherein the set of peripheral manifolds affected by a candidate action that involves end-effector contact includes the haptic manifold, such that federated admissibility evaluation of a contact action requires the projected action state to be epistemically admissible within the haptic manifold.

19. The method of claim 11, wherein upon detecting a cross-manifold coherence failure condition the method further comprises performing at least one of interrupting a current action trajectory in the configuration manifold, initiating a re-planning cycle in the central cognitive manifold, or generating a constraint representation characterizing the detected cross-manifold phase discontinuity and projecting the constraint representation into the irreversible reservoirs of the peripheral manifold in which the discontinuity was localized, and wherein the inter-manifold projection operators through which the cross-manifold path-dependent coherence quantity is accumulated are the same persistent typed mappings used for federated admissibility evaluation, rather than ephemeral structures having bounded lifetimes.

20. The method of claim 11, wherein the plurality of peripheral manifolds further comprises a language manifold encoding command representations derived from voice or text input, and wherein a linguistic projection operator defines a persistent typed mapping from the language manifold to an intentional sub-manifold of the central cognitive manifold, and wherein the linguistic projection operator carries an admissibility condition that denies mapping of a command representation that would project to a forbidden region of the intentional sub-manifold or that conflicts with committed goal states within the intentional sub-manifold, and wherein reverse projection from the central cognitive manifold through the linguistic projection operator to the language manifold generates verbal or textual status expressions that are consistent with the current geometric state of the central cognitive manifold.
